(19) United States
(12) Patent Application Publication
(10) Pub. No.: US 2024/0213479 A1
(43) Pub. Date: Jun. 27, 2024

(54) ELECTRODE COMPOSITION, ELECTRODE SHEET FOR ALL-SOLID STATE SECONDARY BATTERY, ALL-SOLID STATE SECONDARY BATTERY, AND MANUFACTURING METHODS FOR ELECTRODE COMPOSITION, ELECTRODE SHEET FOR ALL-SOLID STATE SECONDARY BATTERY, AND ALL-SOLID STATE SECONDARY BATTERY

(71) Applicant: FUJIFILM Corporation, Tokyo (JP)

(72) Inventor: Hideyuki SUZUKI, Kanagawa (JP)

(73) Assignee: FUJIFILM Corporation, Tokyo (JP)

(21) Appl. No.: 18/406,196

(22) Filed: Jan. 7, 2024

Related U.S. Application Data
(63) Continuation of application No. PCT/JP2022/036065, filed on Sep. 28, 2022.

(30) Foreign Application Priority Data
Sep. 29, 2021 (JP) 2021-159109
Sep. 14, 2022 (JP) 2022-146225

(51) Int. Cl. H01M 4/62; H01M 4/02; H01M 4/04; H01M 10/0562

(52) U.S. Cl. CPC H01M 4/622; H01M 4/0407; H01M 10/0562; H01M 2004/027; H01M 2004/028; H01M 2300/0065

(57) ABSTRACT

There are provided an electrode composition that realizes excellent dispersion characteristics and a firm bonding property of solid particles while making it possible to reduce a content of a polymer binder, an electrode sheet for an all-solid state secondary battery and an all-solid state secondary battery, which are formed of this electrode composition, and manufacturing methods for an electrode sheet for an all-solid state secondary battery and an all-solid state secondary battery. The electrode composition is an electrode composition containing an inorganic solid electrolyte, an active material, a polymer binder, and a dispersion medium, where the polymer binder includes a polymer binder A which is dissolved in the dispersion medium, in which an adsorption rate with respect to the active material is 20% or more and is higher than an adsorption rate with respect to the inorganic solid electrolyte, and a polymer binder B which is dissolved in the dispersion medium, in which an adsorption rate with respect to the inorganic solid electrolyte is 20% or more and is higher than an adsorption rate with respect to the active material.

### CROSS-REFERENCE TO RELATED APPLICATIONS

This application is a Continuation of PCT International Application No. PCT/JP2022/036065 filed on Sep. 28, 2022, which claims priority under 35 U.S.C. § 119 (a) to Japanese Patent Application No. 2021-159109 filed in Japan on Sep. 29, 2021, and Japanese Patent Application No. 2022-146225 filed in Japan on Sep. 14, 2022. Each of the above applications is hereby expressly incorporated by reference, in its entirety, into the present application.

### BACKGROUND OF THE INVENTION

### 1. Field of the Invention

The present invention relates to an electrode composition, an electrode sheet for an all-solid state secondary battery, an all-solid state secondary battery, and manufacturing methods for the electrode composition, the electrode sheet for an all-solid state secondary battery, and the all-solid state secondary battery.

### 2. Description of the Related Art

In all-solid state secondary batteries, since all of the negative electrode, the electrolyte, and the positive electrode are solid, safety and reliability that are considered as a problem of batteries in which the organic electrolytic solution is used can be significantly improved. It is also said to be capable of extending the battery life. Further, an all-solid state secondary battery can be provided with a structure in which the electrode and the electrolyte are directly disposed in series. As a result, it is possible to increase the energy density to be high as compared with a secondary battery in which an organic electrolytic solution is used, and thus the application to electric vehicles, large-sized storage batteries, and the like is anticipated.

In such an all-solid state secondary battery, examples of the substance that forms an active material layer (also referred to as an electrode layer) include an inorganic solid electrolyte and an active material. This inorganic solid electrolyte, particularly an oxide-based inorganic solid electrolyte or a sulfide-based inorganic solid electrolyte is expected as an electrolyte material having a high ion conductivity comparable to that of the organic electrolytic solution. As a material that forms an active material layer of an all-solid state secondary battery (also referred to as an active material layer forming material or an electrode composition), materials (for example, a slurry composition) obtained by dispersing or dissolving the above-described inorganic solid electrolyte and active material, as well as a binder (a binding agent) and the like in a dispersion medium have been proposed, and among them, a material in which two kinds of binders are used in combination has also been proposed. For example, JP2015-244428A describes a mixed material containing a solid electrolyte, an active material, a non-polar solvent, a first binding agent insoluble in a non-polar solvent, and a second binding agent soluble in a non-polar solvent, where an SP value of the first binding agent is different from that of the second binding agent.

### SUMMARY OF THE INVENTION

In a case of forming an active material layer with solid particle materials (an inorganic solid electrolyte, an active material, conductive auxiliary agent, and the like), an active material layer forming material and a binder that is used for the active material layer forming material are required to have various characteristics from the viewpoint of the improvement of the battery performance of the all-solid state secondary battery (for example, the reduction of the battery resistance and the improvement of the rate characteristics or cycle characteristics) and the like. For example, the active material layer forming material is required to be excellent in the dispersion stability that stably maintains a favorable initial dispersibility of a solid particle material (also referred to as solid particles) immediately after preparation (the initial dispersibility and the dispersion stability are collectively referred to as dispersion characteristics). In addition, an active material layer formed of the active material layer forming material is required to have a bonding property (adhesiveness) which causes solid particles to be firmly bound (adhere). On the other hand, since the binder is inferior in ionic conductivity and electron conductivity, it is required to reduce the content thereof in the active material layer forming material and the active material layer from the viewpoint of the suppression of the increase in battery resistance.

As described above, the active material layer forming material is required to achieve both contradictory characteristics, such as realizing dispersion characteristics of solid particles and a firm bonding property thereof while reducing the content of the binder.

An object of the present invention is to provide an electrode composition that realizes excellent dispersion characteristics and a firm bonding property of solid particles while making it possible to reduce a content of a polymer binder. In addition, another object of the present invention is to provide an electrode sheet for an all-solid state secondary battery and an all-solid state secondary battery, which are formed of this electrode composition, and manufacturing methods for an electrode composition, an electrode sheet for an all-solid state secondary battery, and an all-solid state secondary battery.

In the active material forming material in the related art, a binder that disperses and binds these solid particles as a whole has been selected assuming a solid particle group containing an inorganic solid electrolyte, an active material, and the like as a homogeneous mixture even in a case where improvements such as changing the mixing order are made.

However, as a result of diligent studies on an active material layer forming material, the inventors of the present invention reached a conclusion that since in general, in a case where a binder enhances an interaction with an inorganic solid electrolyte, an interaction with an active material is also increased in conjunction therewith, it is not sufficient to achieve both the dispersion characteristics and bonding property of the solid particle group and the reduction of the binder content at the same time even in a case of assuming a solid particle group containing an inorganic solid electrolyte and an active material as an integrated mixture and studying a binder to be used in combination therewith. Therefore, as a result of further studies, the inventors of the present invention reached an idea that in an active material layer forming material containing an active material, an inorganic solid electrolyte, and a dispersion medium, an inorganic solid electrolyte and an active material are deliberately assumed as separate groups of solid particles instead of assuming groups of the respective kinds of solid particles containing an inorganic solid electrolyte and an active material as an integrated mixture, and a binder with respect to each solid particle group is improved. Based on this idea, the inventors of the present invention found that in a case of using in combination, a binder that can be preferentially adsorbed to an active material and a binder that can be preferentially adsorbed to an inorganic solid electrolyte among binders that are dissolved in a dispersion medium, it is possible to stably disperse each of the active material and the inorganic solid electrolyte in the active material layer forming material not only immediately after the adjustment but also after a lapse of time while reducing the total content of the binder (it is possible to have excellent in dispersion characteristics), and it is possible to form an active material layer in which each of the active material and the inorganic solid electrolyte is firmly bound. In addition, it was also found that this active material layer forming material makes it possible to realize a low-resistance active material layer in which solid particles are firmly bound, and moreover, an all-solid state secondary battery into which this active material layer is incorporated has low resistance and makes it possible to realize excellent battery performance.

The present invention has been completed through further studies based on these findings.

That is, the above problems have been solved by the following means.
<1> An electrode composition comprising:
an inorganic solid electrolyte having an ion conductivity of a metal belonging to Group 1 or Group 2 in the periodic table;
an active material;
a polymer binder; and
a dispersion medium,
in which the polymer binder includes;
a polymer binder A that is a polymer binder which is dissolved in the dispersion medium, where an adsorption rate with respect to the active material in the dispersion medium is 20% or more and is higher than an adsorption rate with respect to the inorganic solid electrolyte, and
a polymer binder B that is a polymer binder which is dissolved in the dispersion medium, where an adsorption rate with respect to the inorganic solid electrolyte in the dispersion medium is 20% or more and is higher than an adsorption rate with respect to the active material.
<2> The electrode composition according to <1>, further comprising a conductive auxiliary agent according to <1>.
<3> The electrode composition according to <1> or <2>, in which a polymer that forms at least one of the polymer binder A or the polymer binder B contains a constitutional component having a functional group selected from the following group (a) of functional groups,

### <Group (a) of Functional Groups>

a hydroxy group, an amino group, a carboxy group, a sulfo group, a phosphate group, a phosphonate group, a sulfanyl group, an ether bond, an imino group, an amide bond, an imide bond, a urethane bond, a urea bond, a heterocyclic group, an aryl group, and a carboxylic acid anhydride group.
<4> The electrode composition according to any one of <1> to <3>, in which a polymer that forms the polymer binder A has, in a main chain, at least one bond of a urethane bond, a urea bond, an amide bond, an imide bond, or an ester bond.
<5> The electrode composition according to any one of <1> to <4>, in which a polymer that forms the polymer binder B is obtained by polymerizing a monomer having a carbon-carbon unsaturated bond.
<6> The electrode composition according to any one of <1> to <5>, in which a content of the polymer binder A is 1.5% by mass or less in 100% by mass of a solid content of the electrode composition, and a content of the polymer binder B is 1.5% by mass or less in 100% by mass of the solid content of the electrode composition.
<7> An electrode sheet for an all-solid state secondary battery, comprising:
an active material layer formed of the electrode composition according to any one of <1> to <6>.
<8> An all-solid state secondary battery comprising, in the following order:
a positive electrode active material layer;
a solid electrolyte layer; and
a negative electrode active material layer,
in which at least one of the positive electrode active material layer or the negative electrode active material layer is an active material layer formed of the electrode composition according to any one of <1> to <6>.
<9> A production method for an electrode composition, which is a production method for the electrode composition according to any one of <1> to <6>, the production method comprising:
a step of preparing an active material composition containing the active material, the polymer binder A, and the dispersion medium;
a step of preparing a solid electrolyte composition containing the inorganic solid electrolyte, the polymer binder B, and the dispersion medium; and
a step of mixing the active material composition with the solid electrolyte composition.
<10> A manufacturing method for an electrode sheet for an all-solid state secondary battery, the manufacturing method comprising:
forming a film of the electrode composition according to any one of <1> to <6>.
<11> A manufacturing method for an all-solid state secondary battery, comprising:
manufacturing an all-solid state secondary battery through the manufacturing method according to <10>.

The present invention can provide an electrode composition that realizes excellent dispersion characteristics and a firm bonding property of solid particles while making it possible to reduce a content. In addition, according to the present invention, it is possible to provide an electrode sheet for an all-solid state secondary battery and an all-solid state secondary battery, which have an active material layer composed of the above electrode composition. Further, the present invention can provide respective manufacturing methods for an electrode composition, an electrode sheet for an all-solid state secondary battery, and an all-solid state secondary battery.

### BRIEF DESCRIPTION OF THE DRAWINGS

FIG. 1 is a vertical cross-sectional view schematically illustrating an all-solid state secondary battery according to a preferred embodiment of the present invention.

### DESCRIPTION OF THE PREFERRED EMBODIMENTS

In the present invention, a numerical value range indicated using “to” means a range including numerical values before and after the “to” as the lower limit value and the upper limit value. In a case where a plurality of numerical value ranges are set and described for the content, physical properties, and the like of a component in the present invention, the upper limit value and the lower limit value, which form each of the numerical value ranges, are not limited to a combination of a specific upper limit value and a specific lower limit value described before and after “to” as a specific numerical value range and can be set to a numerical value range obtained by appropriately combining the upper limit value and the lower limit value of each numerical value range.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect not having a substituent but also an aspect having a substituent. The same shall be applied to a compound that is not specified in the present specification regarding whether to be substituted or unsubstituted. Examples of the preferred examples of the substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymer; however, it has the same meaning as a so-called polymeric compound. In addition, a polymer binder (also simply referred to as a binder) means a binder composed of a polymer and includes a polymer itself and a binder composed (formed) by containing a polymer.

In the present invention, a composition containing an inorganic solid electrolyte, an active material, and a dispersion medium and used as a material (an active material layer forming material) that forms an active material layer of an all-solid state secondary battery is referred to as an electrode composition for an all-solid state secondary battery or simply an electrode composition. On the other hand, a composition containing an inorganic solid electrolyte and used as a material that forms a solid electrolyte layer of an all-solid state secondary battery is referred to as an inorganic solid electrolyte-containing composition, where this composition generally does not contain an active material.

In the present invention, the electrode composition includes a positive electrode composition containing a positive electrode active material and a negative electrode composition containing a negative electrode active material. Therefore, any one of the positive electrode composition and the negative electrode composition, or collectively both of them may be simply referred to as an electrode composition, and any one of the positive electrode active material layer and the negative electrode active material layer, or collectively both of them may be simply referred to as an active material layer or an electrode active material layer. Further, in the present invention, any one of the positive electrode active material and the negative electrode active material, or collectively both of them may be simply referred to as an active material or an electrode active material.

### [Electrode Composition]

The electrode composition according to the embodiment of the present invention contains an inorganic solid electrolyte (SE) having an ion conductivity of a metal belonging to Group 1 or Group 2 of the periodic table, an active material (AC), a polymer binder (PB), and a dispersion medium (D). In addition, this polymer binder (PB) includes a polymer binder A that is dissolved in the dispersion medium (D) and satisfies the following adsorption rate, and it includes a polymer binder B that is dissolved in the dispersion medium (D) and satisfies the following adsorption rate. It suffices that one kind of each of the polymer binder A and the polymer binder B is contained in the electrode composition, or two or more kinds thereof may be contained therein.

Polymer binder A: The adsorption rate with respect to the active material (AC) in the dispersion medium (D) is 20% or more and is higher than the adsorption rate with respect to the inorganic solid electrolyte (SE).

Polymer binder B: The adsorption rate with respect to the inorganic solid electrolyte (SE) in the dispersion medium (D) is 20% or more and is higher than the adsorption rate with respect to the active material (AC).

According to the electrode composition according to the embodiment of the present invention, which causes the polymer binder A and the polymer binder B to be contained in combination in the dispersion medium (D) as the polymer binder (PB) with respect to the inorganic solid electrolyte (SE) and the active material (AC), even in a case where the total content of the polymer binders (particularly, the total content of the polymer binders A and B) is reduced, the inorganic solid electrolyte (SE) and the active material (AC) can be stably dispersed not only immediately after the adjustment but also after a lapse of time (has excellent dispersion characteristics), and further, in the formation of a film of the electrode composition, the inorganic solid electrolyte (SE) and the active material (AC) can be allowed to firmly adhere. Therefore, in a case of using this electrode composition as an active material layer forming material, it is possible to realize a low-resistance active material layer in which the inorganic solid electrolyte (SE) and the active material (AC) are firmly bound, and furthermore, an all-solid state secondary battery that has low resistance and exhibits excellent battery characteristics.

Although the details of the reason for the above are not yet clear, it is conceived to be as follows.

The electrode composition according to the embodiment of the present invention contains the polymer binder A that exhibits high adsorptivity with respect to (is preferentially adsorbed to) the active material (AC) as compared the adsorptivity with respect to the inorganic solid electrolyte (SE), and the polymer binder B that exhibits high adsorptivity with respect to (is preferentially adsorbed to) the inorganic solid electrolyte (SE) as compared the adsorptivity with respect to the active material (AC). In this electrode composition, it is presumed that although the preferential adsorption amounts of the polymer binders A and B with respect to the active material (AC) or the inorganic solid electrolyte (SE) cannot be unambiguously determined since they vary depending on the adsorption rate of each binder, the difference in the adsorption rate, the content of each component, the kind of the dispersion medium (D), as well as the preparation method or conditions for the electrode composition, a large number of the polymer binders A that exhibit the above-described adsorption rate are present by being adsorbed to the active material (AC), and a large number of the polymer binders B are present by being adsorbed to the inorganic solid electrolyte (SE). As a result, the polymer binder A can enhance the dispersibility of the active material (AC) which has been preferentially adsorbed, and the polymer binder B can enhance the dispersibility of the inorganic solid electrolyte (SE) which has been preferentially adsorbed. Moreover, it is conceived that both the polymer binders A and B are dissolved in the dispersion medium (D) to spread the molecular chain thereof, which causes the adsorbed active material (AC) or inorganic solid electrolyte (SE) to repel with each other, thereby being capable of suppressing (re)aggregation or precipitation (exhibiting excellent dispersion characteristics). Further, it is conceived that the adsorption state and the dispersion state between the above-described polymer binder and the active material (AC) or inorganic solid electrolyte (SE) are maintained even in a case of formation of a film of the electrode composition, and as a result, in the active material layer that has been formed into a film, the active material (AC) or the inorganic solid electrolyte (SE) is firmly bound while maintaining a high dispersion state. Moreover, in a case of being used in combination, the polymer binders A and B can be separately adsorbed to the active material (AC) and the inorganic solid electrolyte (SE) to make the active material (AC) and the inorganic solid electrolyte (SE) be dispersed and bound, and thus it is possible to reduce the amount of the polymer binder required to disperse and bond the active material (AC) and the inorganic solid electrolyte (SE). As a result, it is possible to suppress the inhibition of the construction of each of the ion conduction path and the electron conduction path due to the polymer binder (PB). Further, it is conceived that since an active material layer can be formed while maintaining the above-described high dispersion state, the inorganic solid electrolyte (SE) and the active material (AC) are less likely to be unevenly distributed, and thus it is possible to suppress the variation in the contact state in the active material layer.

As described above, in a case of forming an active material layer using the electrode composition that realizes excellent dispersion characteristics and a firm bonding property of the inorganic solid electrolyte (SE) and the active material (AC) while making it possible to reduce the content of the polymer binder, it is possible to form an active material layer in which the inorganic solid electrolyte (SE) and the active material (AC) are firmly bound while ensuring the direct contact while suppressing the uneven distribution of the inorganic solid electrolyte (SE) and the active material (AC). As a result, it is conceived that an all-solid state secondary battery into which this active material layer is incorporated has low resistance (exhibits a high ion conductivity and a high electron conductivity) and exhibits excellent battery characteristics such as rate characteristics.

It is conceived that in the electrode composition, the polymer binders A and B are adsorbed to the active material (AC) or the inorganic solid electrolyte (SE) or interposed between solid particles in a state of being dissolved in the dispersion medium (D), thereby exhibiting a function of dispersing the active material (AC) or the inorganic solid electrolyte (SE) in the dispersion medium (D). On the other hand, it is conceived that in the active material layer, the polymer binders A and B function as a binding agent that is adsorbed to the active material (AC) or the inorganic solid electrolyte (SE) and binds them to each other. It is noted that although each of the polymer binders A and B is preferentially adsorbed to the active material (AC) or the inorganic solid electrolyte (SE), it may be adsorbed to the inorganic solid electrolyte (SE) or the active material (AC).

Here, the adsorption of the polymer binders A and B with respect to the active material (AC) or the inorganic solid electrolyte (SE) is not particularly limited; however, it includes not only physical adsorption but also chemical adsorption (adsorption by chemical bond formation, adsorption by transfer of electrons, or the like).

In addition, the polymer binders A and B may also function as a binding agent that binds a collector to solid particles.

Due to having excellent characteristics described above, such an electrode composition can be preferably used as a material for forming an active material layer (a constitutional layer forming material) of an electrode sheet for an all-solid state secondary battery and an all-solid state secondary battery. In particular, it can be preferably used as a material that forms a positive electrode active material layer.

The electrode composition according to the embodiment of the present invention is preferably a slurry in which an inorganic solid electrolyte and an active material are dispersed in a dispersion medium.

The electrode composition according to the embodiment of the present invention is preferably a non-aqueous composition. In the present invention, the non-aqueous composition includes not only an aspect including no watery moisture but also an aspect where the water content (also referred to as the “watery moisture content”) is preferably 500 ppm or less. In the non-aqueous composition, the water content is more preferably 200 ppm or less, still more preferably 100 ppm or less, and particularly preferably 50 ppm or less. In a case where the electrode composition is a non-aqueous composition, it is possible to suppress the deterioration of the inorganic solid electrolyte. The water content refers to the amount of water (the mass proportion thereof to the electrode composition) in the electrode composition and specifically is a value measured by Karl Fischer titration after carrying out filtering through a membrane filter having a pore size of 0.02 μm.

Hereinafter, the components that are included in the electrode composition according to the embodiment of the present invention and components that may be included therein will be described.

### <Inorganic Solid Electrolyte (SE)>

The electrode composition according to the embodiment of the present invention contains the inorganic solid electrolyte (SE).

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity.

As the inorganic solid electrolyte contained in the electrode composition according to the embodiment of the present invention, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

In a case where the all-solid state secondary battery according to the embodiment of the present invention is a lithium ion battery, the inorganic solid electrolyte preferably has a lithium ion conductivity.

### (i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity; however, the sulfide-based inorganic solid electrolytes may appropriately include elements other than Li, S, and P.

Examples of the sulfide-based inorganic solid electrolyte include a lithium ion-conductive inorganic solid electrolyte satisfying the composition represented by Formula (S1).

Lₐ₁M_{b1}P_{c1}S_{d1}Aₑ₁ (S1)

In Formula (S1), L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂) described above.

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited but practically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatment can be carried out at a normal temperature, whereby it is possible to simplify manufacturing steps.

### (ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc}(M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number of 0 or more and 0.1 or less, and M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure. In addition, a phosphorus compound containing Li, P, or O is also desirable. Examples thereof include lithium phosphate (Li₃PO₄); LiPON in which a part of oxygen elements in lithium phosphate are substituted with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

### (iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable.

In a case where the inorganic solid electrolyte has a particle shape, the particle diameter (volume average particle diameter) of the inorganic solid electrolyte is not particularly limited; however, it is preferably 0.01 μm or more, more preferably 0.1 μm or more, and still more preferably 0.5 μm or more. The upper limit thereof is preferably 100 μm or less, more preferably 50 μm or less, and still more preferably 10 μm or less.

The particle diameter of the inorganic solid electrolyte is measured according to the following procedure. Using water (heptane in a case where the inorganic solid electrolyte is unstable in water), the particles of the inorganic solid electrolyte are diluted in a 20 mL sample bottle to prepare 1% by mass of a dispersion liquid. The diluted dispersion liquid sample is irradiated with 1 kHz ultrasonic waves for 10 minutes and is then immediately used for testing. Using this dispersion liquid sample, data collection is carried out 50 times by using a laser scattering-type particle size distribution analyzer LA-920 (product name, manufactured by Horiba Ltd.) and using a quartz cell for measurement at a temperature of 25° C. to obtain the volume average particle diameter. Other detailed conditions and the like can be found in Japanese Industrial Standards (JIS) Z8828: 2013 “Particle Diameter Analysis-Dynamic Light Scattering Method” as necessary. Five samples per level are produced and measured, and the average values thereof are employed.

The method of adjusting the particle diameter is not particularly limited, and a known method can be applied. Examples thereof include a method using a normal pulverizer or a classifier. As the pulverizer or a classifier, for example, a mortar, a ball mill, a sand mill, a vibration ball mill, a satellite ball mill, a planetary ball mill, a swirling airflow-type jet mill, or a sieve is suitably used. During pulverization, it is possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

The inorganic solid electrolyte contained in the electrode composition may be one kind or two or more kinds.

The content of the inorganic solid electrolyte (SE) in the electrode composition is not particularly limited and is appropriately determined. For example, from the viewpoint of dispersion characteristics and a bonding property, it is preferably 50% by mass or more, more preferably 70% by mass or more, and particularly preferably 90% by mass or more, in 100% by mass of the solid content in terms of the total with the active material (AC). From the same viewpoint, the upper limit thereof is preferably 99.9% by mass or less, more preferably 99.5% by mass or less, and particularly preferably 99% by mass or less.

In the present invention, the solid content (solid component) refers to components that neither volatilize nor evaporate and disappear in a case where the electrode composition is subjected to drying treatment at 150° C. for 6 hours in a nitrogen atmosphere at a pressure of 1 mmHg. Typically, the solid content refers to a component other than the dispersion medium (D) described later. In addition, the content in the total solid content indicates the content in 100% by mass of the total mass of the solid content.

The ratio of the content of the inorganic solid electrolyte (SE) to the content of the active material described below [content of inorganic solid electrolyte (SE):content of active material] in 100% by mass of the solid content of the electrode composition is not particularly limited; however, it is, for example, preferably 1:1 to 1:6 and more preferably 1:1.2 to 1:5.

### <Active Material (AC)>

The electrode composition according to the embodiment of the present invention contains an active material (AC) capable of intercalating and deintercalating ions of a metal belonging to Group 1 or Group 2 in the periodic table.

Examples of such active materials include a positive electrode active material (AC) and a negative electrode active material, which will be described later.

### (Positive Electrode Active Material)

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, or V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The positive electrode active material contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable.

In a case where the positive electrode active material has a particle shape, the particle diameter (volume average particle diameter) of the positive electrode active material is not particularly limited; however, it is, for example, preferably 0.1 to 50 μm and more preferably 0.5 to 10 μm. The particle diameter of the positive electrode active material particle can be adjusted in the same manner as in the adjustment of the particle diameter of the inorganic solid electrolyte, and the particle diameter thereof can be measured by the same measuring method as the measuring method for the particle diameter of the inorganic solid electrolyte.

A positive electrode active material obtained using a baking method may be used after being washed with water, an acidic aqueous solution, an alkaline aqueous solution, or an organic solvent.

The positive electrode active material contained in the electrode composition according to the embodiment of the present invention may be one kind or two or more kinds.

The content of the positive electrode active material in the electrode composition is not particularly limited and is appropriately determined. For example, it is preferably 10% to 97% by mass, more preferably 30% to 95% by mass, still more preferably 40% to 93% by mass, and particularly preferably 50% to 90% by mass in 100% by mass of the solid content.

### (Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Further, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the surface spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are preferably noncrystalline oxides, and preferred examples thereof include chalcogenides which are reaction products between metal elements and elements in Group 16 of the periodic table. In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 200 to 400 in terms of 20 value in case of being measured by an X-ray diffraction method using CuKα rays, and the oxide may have a crystalline diffraction line. The highest intensity in a crystalline diffraction line observed in a range of 400 to 700 in terms of 20 value is preferably 100 times or less and more preferably 5 times or less with respect to the intensity of a diffraction line at the apex in a broad scattering band observed in a range of 200 to 400 in terms of 20 value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanate [LTO]) is preferable since the volume variation during the intercalation and deintercalation of lithium ions is small, and thus the high-speed charging and discharging characteristics are excellent, and the deterioration of electrodes is suppressed, whereby it is possible to improve the life of the lithium ion secondary battery.

The lithium alloy as the negative electrode active material is not particularly limited as long as it is an alloy that is usually used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is usually used as a negative electrode active material for a secondary battery. Such an active material has a large expansion and contraction due to charging and discharging of the all-solid state secondary battery and accelerates the deterioration of the cycle characteristics. However, since the electrode composition according to the embodiment of the present invention contains the polymer binders A and B described above, and thus it is possible to suppress the deterioration of the cycle characteristics. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including the tin element include Sn, SnO, SnO₂, SnS, SnS₂, and the above-described active material including the silicon element and the tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is still more preferable to include a negative electrode active material containing silicon (Si) or a silicon-containing alloy.

The negative electrode active material contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable.

In a case where the negative electrode active material has a particle shape, the particle diameter (volume average particle diameter) of the negative electrode active material is not particularly limited; however, it is, for example, preferably 0.1 to 60 μm and more preferably 0.5 to 10 μm. The particle diameter of the negative electrode active material particle can be adjusted in the same manner as in the adjustment of the particle diameter of the inorganic solid electrolyte, and the particle diameter thereof can be measured by the same measuring method as the measuring method for the particle diameter of the inorganic solid electrolyte.

The negative electrode active material contained in the electrode composition according to the embodiment of the present invention may be one kind or two or more kinds.

The content of the negative electrode active material in the electrode composition is not particularly limited and is appropriately determined. For example, it is preferably 10% to 90% by mass, more preferably 20% to 85% by mass, still more preferably 30% to 80% by mass, and even still more preferably 40% to 75% by mass in 100% by mass of the solid content.

In the present invention, a negative electrode active material layer can be formed by charging a secondary battery. In this case, ions of a metal belonging to Group 1 or Group 2 in the periodic table produced in the all-solid state secondary battery can be used instead of the negative electrode active material. By bonding the ions to electrons and precipitating a metal, a negative electrode active material layer can be formed.

The chemical formulae of the compounds obtained by the above baking method can be calculated using an inductively coupled plasma (ICP) emission spectroscopy as a measuring method from the mass difference of powder before and after baking as a convenient method.

### (Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

### <Polymer Binder (PB)>

The polymer binder (PB) contained in the electrode composition according to the embodiment of the present invention contains one kind or two or more kinds of the following polymer binder A and contains one kind or two or more kinds of the following polymer binder B.

Polymer binder A: It is dissolved in the dispersion medium (D), and the adsorption rate with respect to the active material (AC) in the dispersion medium (D) is 20% or more and is higher than the adsorption rate with respect to the inorganic solid electrolyte (SE) (hereinafter, the polymer binder A may be referred to as a binder for AC adsorption).

Polymer binder B: It is dissolved in the dispersion medium (D), and the adsorption rate with respect to the inorganic solid electrolyte (SE) in the dispersion medium (D) is 20% or more and is higher than the adsorption rate with respect to the active material (AC) (hereinafter, the polymer binder B may be referred to as a binder for SE adsorption).

### (Polymer Binder A)

The polymer binder A exhibits a characteristic (solubility) of being dissolved in the dispersion medium (D) contained in the electrode composition. A polymer binder that is dissolved in a dispersion medium is referred to as a soluble type binder. The polymer binder A in the electrode composition generally is present in a state of being dissolved in the dispersion medium (D) in the electrode composition, which depends on the content of the polymer binder A, the solubility described later, the content of the dispersion medium (D), and the like. In this case, the polymer binder A stably exhibits the function of dispersing the active material (AC) in the dispersion medium.

In the present invention, the description that the polymer binder (PB) is dissolved in the dispersion medium (D) refers to that the solubility in the dispersion medium (D) is 10% by mass or more in the solubility measurement. On the other hand, the description that the polymer binder is not dissolved (is insoluble) in a dispersion medium means that the solubility of the dispersion medium (D) in the solubility measurement is less than 10% by mass. The measuring method for solubility is as follows.

A specified amount of the polymer binder (PB) serving as a measurement target is weighed in a glass bottle, 100 g of the same dispersion medium (D) as the dispersion medium (D) contained in the electrode composition is added thereto, and stirring is carried out at a temperature of 25° C. on a mix rotor at a rotation speed of 80 rpm for 24 hours. After stirring for 24 hours, the mixed solution obtained in this way is subjected to the transmittance measurement under the following conditions. This test (the transmittance measurement) is carried out by changing the amount of the polymer binder (PB) dissolved (the above-described specified amount), and the upper limit concentration X (% by mass) at which the transmittance is 99.8% is defined as the solubility of the polymer binder (PB) in the above dispersion medium.

### <Transmittance Measurement Conditions>

### Dynamic Light Scattering (DLS) Measurement

Device: DLS measuring device DLS-8000 manufactured by Otsuka Electronics Co., Ltd.
Laser wavelength, output: 488 nm/100 mW
Sample cell: NMR tube

In the polymer binder A, the adsorption rate A_{AC} with respect to the active material (AC) in the dispersion medium (D) is 20% or more and is higher than the adsorption rate A_{SE} with respect to the inorganic solid electrolyte (SE). As a result, the polymer binder A is preferentially adsorbed to the active material (AC) rather than the inorganic solid electrolyte (SE), thereby being capable of improving the dispersion characteristics and the bonding property of the active material (AC), and the content thereof can also be reduced.

It suffices that the adsorption rate A_{AC} of the polymer binder A is 20% or more, where it is preferably 30% or more, more preferably 40% or more, and still more preferably 60% or more, in terms of the content, the dispersion stability, and the bonding property of the polymer binder. The upper limit value of the adsorption rate A_{AC} is not particularly limited; however, in general, the increase in the adsorption rate A_{AC} resultantly increases the adsorption rate A_{SE} as well, which may inhibit the preferential adsorption to the active material (AC). Therefore, the upper limit value thereof can be set to, for example, 95% or less; however, it is preferably set to 90% or less and more preferably set to 80% or less, and it can also be set to 60%.

The adsorption rate A_{SE} of the polymer binder A is not particularly limited as long as it is smaller than the adsorption rate A_{AC}, and the adsorption rate A_{SE} thereof is appropriately determined depending on the value of the adsorption rate A_{AC}. The adsorption rate A_{SE} is, for example, preferably 45% or less, more preferably 35% or less, still more preferably 20% or less, particularly preferably 15% or less, and most preferably 10% or less.

In the polymer binder A, the difference (A_{AC}−A_{SE}) between the adsorption rate A_{AC} and the adsorption rate A_{SE} is not particularly limited, and it is preferably more than 0%, more preferably 5% or more, and still more preferably 10% or more. The upper limit value thereof is not particularly limited and can be set to, for example, 30%.

In the present invention, the adsorption rate (%) of the polymer binder (PB), that is, the adsorption rate (%) of the polymer binder A or B is a value measured by using the active material (AC) or inorganic solid electrolyte (SE) contained in the electrode composition, and the specific dispersion medium (D), and it is an indicator that indicates the degree of adsorption of the polymer binder (PB) to the active material (AC) or the inorganic solid electrolyte (SE) in this dispersion medium (D). Here, the adsorption of the polymer binder (PB) to the active material (AC)) or the inorganic solid electrolyte (SE) includes not only physical adsorption but also chemical adsorption as described above.

In a case where the electrode composition contains a plurality of kinds of the active material (AC)) or the inorganic solid electrolyte (SE), the adsorption rate shall be defined as an adsorption rate with respect to the active material (AC)) or the inorganic solid electrolyte (SE), which has the same composition (kind and content) as the composition of the active material or the composition of the inorganic solid electrolyte in the electrode composition. Similarly, also in a case where the electrode composition contains a plurality of kinds of specific dispersion media (D), the adsorption rate is measured by using a specific dispersion medium (D) having the same composition (the kind and the content) as the dispersion medium in the electrode composition.

In a case where the electrode composition contains a plurality of kinds of the polymer binder A or B, the adsorption rate is measured for each polymer binder.

Using the active material (AC), the polymer binder (PB), and the dispersion medium (D), which are used in the preparation of the electrode composition, the adsorption rate A_{AC} (%) of the polymer binder (PB) with respect to the active material (AC) is measured as follows.

That is, 1.6 g of the active material (AC) and 0.08 g of the polymer binder (PB) are placed in a vial of 15 ml, 8 g of the dispersion medium (D) is added thereto while stirring with a mix rotor, and further, stirring is carried out at 80 rpm for 30 minutes at room temperature (25° C.). The stirred dispersion liquid is filtered through a filter having a pore diameter of 1 μm, 2 g is collected from a total amount of 8 g of the filtrate and dried, and the mass BY of the dried polymer binder (PB) (the mass of the polymer binder (PB) which has not adsorbed to the active material (AC) is measured.

From the mass BY of the polymer binder (PB) obtained in this way and the mass of 0.08 g of the polymer binder (PB) used, the adsorption rate A_{AC} (%) of the polymer binder (PB) with respect to the active material (AC) is calculated according to the following expression. The average value of the adsorption rates (%) obtained by carrying out this measurement twice is defined as the adsorption rate A_{AC} (%) of the polymer binder (PB).

Adsorption rate A_{AC}(%)=[(0.08−BY×8/2)/0.08]×100

Using the inorganic solid electrolyte (SE), the polymer binder (PB), and the dispersion medium (D), which are used in the preparation of the electrode composition, the adsorption rate A_{SE} (%) of the polymer binder (PB) with respect to the inorganic solid electrolyte (SE) is measured as follows.

That is, 0.5 g of the inorganic solid electrolyte (SE) and 0.26 g of the polymer binder (PB) are placed in a vial of 15 ml, 25 g of the dispersion medium (D) is added thereto while stirring with a mix rotor, and further, stirring is carried out at 80 rpm for 30 minutes at room temperature. The stirred dispersion liquid is filtered through a filter having a pore diameter of 1 m, 2 g is collected from a total amount of 25 g of the filtrate and dried, and the mass BX of the dried polymer binder (PB) (the mass of the polymer binder (PB) which has not adsorbed to the inorganic solid electrolyte (SE) is measured.

From the mass BX of the polymer binder (PB) obtained in this way and the mass of 0.26 g of the polymer binder (PB) used, the adsorption rate A_{SE} (%) of the polymer binder (PB) with respect to the inorganic solid electrolyte (SE) is calculated according to the following expression. The average value of the adsorption rates (%) obtained by carrying out this measurement twice is defined as the adsorption rate A_{SE} (%) of the polymer binder (PB).

Adsorption rate A_{SE}(%)=[(0.26−BX×25/2)/0.26]×100

In the present invention, both adsorption rates of the polymer binder A can be appropriately set depending on the kind of the polymer (the structure and composition of the polymer chain) that forms the polymer binder A, the kind or content of the functional group of the polymer, and the like.

It is noted that the other characteristics of the polymer binder A will be described later.

### <Polymer Binder B>

The polymer binder B exhibits a characteristic of being dissolved in the dispersion medium (D) contained in the electrode composition. The polymer binder B in the electrode composition generally is present in a state of being dissolved in the dispersion medium (D) in the electrode composition, which depends on the content of the polymer binder A, the solubility described later, the content of the dispersion medium (D), and the like. In this case, the polymer binder B stably exhibits the function of dispersing the inorganic solid electrolyte (SE) in the dispersion medium (D).

In the polymer binder B, the adsorption rate A_{SE} with respect to the inorganic solid electrolyte (SE) in the dispersion medium (D) is 20% or more and is higher than the adsorption rate A_{AC} with respect to the active material (AC). As a result, the polymer binder B is preferentially adsorbed to the inorganic solid electrolyte (SE) rather than the active material (AC), thereby being capable of improving the dispersion characteristics and the bonding property of the inorganic solid electrolyte (SE), and the content thereof can also be reduced.

It suffices that the adsorption rate A_{SE} of the polymer binder B is 20% or more, where it is preferably 30% or more, more preferably 40% or more, and still more preferably 60% or more, in terms of the content, the dispersion stability, and the bonding property of the polymer binder. The upper limit value of the adsorption rate A_{SE} is not particularly limited; however, in general, the increase in the adsorption rate A_{SE} resultantly increases the adsorption rate A_{AC} as well, which may inhibit the preferential adsorption to the inorganic solid electrolyte (SE). Therefore, the upper limit value thereof can be set to, for example, 95% or less; however, it is preferably set to 90% or less and more preferably set to 80% or less, and it can also be set to 60%.

The adsorption rate A_{AC} of the polymer binder B is not particularly limited as long as it is smaller than the adsorption rate A_{SE}, and the adsorption rate A_{AC} thereof is appropriately determined depending on the value of the adsorption rate A_{SE}. The adsorption rate A_{AC} is, for example, preferably 35% by mass or lower, more preferably 20% by mass or lower, still more preferably 15% by mass or lower, and particularly preferably 10% by mass or lower.

In the polymer binder B, the difference (A_{SE}−A_{A}C) between the adsorption rate A_{SE} and the adsorption rate A_{AC} is not particularly limited, and it is preferably more than 0%, more preferably 5% or more, and still more preferably 10% or more. The upper limit value thereof is not particularly limited and can be set to, for example, 35%.

The adsorption rate A_{SE} and A_{AC} of the polymer binder B shall be values calculated according to the above-described measuring method.

In the combination of the polymer binder A and the polymer binder B, the difference in the adsorption rate A_{SE} or A_{AC} is not particularly limited; however, from the viewpoint that a higher selective adsorption to the active material (AC) is possible, the difference (in terms of absolute value) in the adsorption rate A_{AC} between the polymer binder A and the polymer binder B is preferably 5% or more, more preferably 10% or more, still more preferably 15% or more, and even still more preferably 30% or more. Similarly, from the viewpoint that a higher selective adsorption to the inorganic solid electrolyte (SE) is possible, the difference (in terms of absolute value) in the adsorption rate A_{SE} between the polymer binder A and the polymer binder B is preferably 5% or more, more preferably 10% or more, and still more preferably 15% or more. The upper limit value of each of the difference (in terms of absolute value) in the adsorption rate A_{AC} and the difference (in terms of absolute value) in the adsorption rate A_{SE} is not particularly limited and can be appropriately determined. For example, a difference (in terms of absolute value) in the adsorption rate A_{AC} is preferably 60% or less and more preferably 50% or less. On the other hand, the difference (in terms of absolute value) in the adsorption rate A_{SE} is preferably 30% or less and more preferably 20% or less, and it can be also set to 10% or less.

In the present invention, both adsorption rates of the polymer binder B can be appropriately set depending on the kind of the polymer (the structure and composition of the polymer chain) that forms the polymer binder B, the kind or content of the functional group of the polymer, and the like.

It is noted that the other characteristics of the polymer binder B will be described later.

—Polymers that Form Polymer Binders A and B—

Each of polymers that form the polymer binder A or B is not particularly limited as long as it imparts solubility to the polymer binder in the dispersion medium (D) and satisfies the adsorption rate with respect to the active material (AC) or the inorganic solid electrolyte (SE), and various polymers can be used. Among them, preferred examples thereof include a polymer having, in the main chain, at least one bond selected from a urethane bond, a urea bond, an amide bond, an imide bond, and an ester bond, or a polymerized chain of carbon-carbon double bonds. In the present invention, the polymerized chain of carbon-carbon double bonds refers to as a polymerized chain that is obtained by polymerizing carbon-carbon double bonds (ethylenically unsaturated groups), and specifically, it refers to a polymerized chain obtained by polymerizing (homopolymerizing or copolymerizing) a monomer having a carbon-carbon unsaturated bond.

In the present invention, a main chain of the polymer refers to a linear molecular chain in which all the molecular chains that constitute the polymer other than the main chain can be conceived as a branched chain or a pendant group with respect to the main chain. Although it depends on the mass average molecular weight of the molecular chain regarded as a branched chain or pendant chain, the longest chain among the molecular chains that constitute the polymer is typically the main chain. In this case, a terminal group at the polymer terminal is not included in the main chain. In addition, side chains of the polymer refer to molecular chains other than the main chain and include a short molecular chain and a long molecular chain.

The above bond is not particularly limited as long as it is contained in the main chain of the polymer, and it may have any aspect in which it is contained in the constitutional unit (the repeating unit) and/or an aspect in which it is contained as a bond that connects different constitutional units to each other. Further, the above-described bond contained in the main chain is not limited to one kind, it may be 2 or more kinds, and it is preferably 1 to 6 kinds and more preferably 1 to 4 kinds. In this case, the bonding mode of the main chain is not particularly limited. The main chain may randomly have two or more kinds of bonds and may be a main chain that is segmented to a segment having a specific bond and a segment having another bond.

The main chain having the above bond is not particularly limited. However, it is preferably a main chain that has at least one segment among the above bonds, more preferably a main chain consisting of polyamide, polyurea, polyurethane, and (meth)acrylic polymer, and still more preferably a main chain consisting of polyurethane or a (meth)acrylic polymer.

Examples of the polymer having, among the above bonds, a urethane bond, a urea bond, an amide bond, an imide bond, or an ester bond in the main chain include sequential polymerization (polycondensation, polyaddition, or addition condensation) polymers such as polyurethane, polyurea, polyamide, polyimide, and polyester, and copolymers thereof. The copolymer may be a block copolymer having each of the above polymers as a segment, or a random copolymer in which each constitutional component that constitutes two or more polymers among the above polymers is randomly bonded.

Examples of the polymer having a polymerized chain of carbon-carbon double bonds in the main chain, that is, a polymer having in the main chain a polymerized chain obtained by polymerizing a monomer having a carbon-carbon unsaturated bond include chain polymerization polymers such as a fluoropolymer (a fluorine-containing polymer), a hydrocarbon polymer, a vinyl polymer, and a (meth)acrylic polymer. The polymerization mode of these chain polymerization polymers is not particularly limited, and the chain polymerization polymer may be any of a block copolymer, an alternating copolymer, or a random copolymer.

The polymer that forms the above-described binder may be one kind or two or more kinds.

The polymer that forms the above-described binder preferably has a constitutional component represented by any one of Formulae (1-1) to (1-5) and more preferably has a constitutional component represented by Formula (1-1) or formula (1-2).

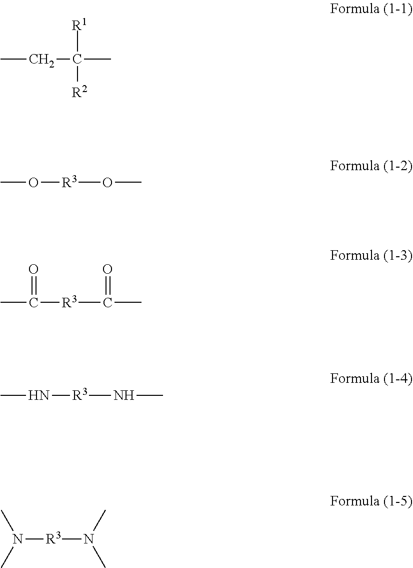

In Formula (1-1), R¹ represents a hydrogen atom or an alkyl group (preferably having 1 to 12 carbon atoms, more preferably 1 to 6 carbon atoms, and still more preferably 1 to 3 carbon atoms). The alkyl group that can be adopted as R¹ may have a substituent. The substituent is not particularly limited; however, examples thereof include a substituent Z described later. A group other than the functional group selected from the Group (a) of functional groups is preferable, and suitable examples thereof include a halogen atom.

R² represents a group having a hydrocarbon group having 4 or more carbon atoms. In the present invention, the group having a hydrocarbon group includes a group consisting of the hydrocarbon group itself (where the hydrocarbon group is directly bonded to the carbon atom in the above formula, to which R¹ is bonded) and a group consisting of a linking group (where a hydrocarbon group is bonded to the carbon atom in the above formula via a linking group, to which R¹ is bonded) that links the carbon atom in the above formula, to which R² is bonded, to a hydrocarbon group.

The hydrocarbon group is a group composed of a carbon atom and a hydrogen atom, and it is generally introduced at the end portion of R². The hydrocarbon group is not particularly limited; however, it is preferably an aliphatic hydrocarbon group, more preferably an aliphatic saturated hydrocarbon group (an alkyl group), and still more preferably a linear or branched alkyl group. It suffices that the hydrocarbon group has 4 or more carbon atoms, and the hydrocarbon group preferably has 6 or more carbon atoms and more preferably 8 or more carbon atoms, and it can be set to have 10 or more carbon atoms. The upper limit of the carbon atoms thereof is not particularly limited, and it is preferably 20 or less and more preferably 14 or less.

The linking group is not particularly limited; however, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—. R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group involved in the combination thereof. It is also possible to form a polyalkyleneoxy chain by combining an alkylene group and an oxygen atom. The linking group is preferably a group composed of a combination of an alkylene group, an arylene group, a carbonyl group, an oxygen atom, a sulfur atom, and an imino group, more preferably a group composed of a combination of an alkylene group, an arylene group, a carbonyl group, an oxygen atom, and an imino group, still more preferably a group containing a —CO—O— group, a —CO—N(R^{N})— group (here, R^{N} is as described above), and particularly preferably a —CO—O— group or a —CO—N(R^{N})— group (here, R^{N} is as described above). The number of atoms that constitute the linking group and the number of linking atoms are as described later. However, the above does not apply to the polyalkyleneoxy chain that constitutes the linking group.

In the present invention, the number of atoms that constitute the linking group is preferably 1 to 36, more preferably 1 to 24, still more preferably 1 to 12, and particularly preferably 1 to 6. The number of linking atoms of the linking group is preferably 10 or less and more preferably 8 or less. The lower limit thereof is 1 or more. The number of linking atoms refers to the minimum number of atoms linking predetermined structural parts. For example, in a case of —CH₂—C(═O)—O—, the number of atoms that constitute the linking group is 6; however, the number of linking atoms is 3.

Each of the hydrocarbon group and the linking group may have or may not have a substituent. Examples of the substituent which may be contained therein include a substituent Z. A group other than the functional group selected from the group (a) of functional groups is preferable, and suitable examples thereof include a halogen atom.

In Formula (1-1), the carbon atom adjacent to the carbon atom to which R¹ is bonded has two hydrogen atoms; however, in the present invention, it may have one or two substituents. The substituent is not particularly limited; however, examples thereof include a substituent Z described later, and a group other than the functional group selected from the Group (a) of functional groups is preferable.

The compound from which a constitutional component represented by Formula (1-1) is derived is not particularly limited; however, examples thereof include a (meth)acrylic acid linear alkyl ester compound (here, linear alkyl means an alkyl group having 4 or more carbon atoms).

In Formula (1-2) to Formula (1-5), R³ represents a linking group of which the mass average molecular weight or number average molecular weight (hereinafter, referred to as a mass average molecular weight or the like) is 500 or more and 200,000 or less, which contains a polybutadiene chain or a polyisoprene chain.

The terminal of the chain that can be adopted as R³ can be appropriately changed to a typical chemical structure that can be incorporated as R³ into the constitutional components represented by the above formulae.

In each of the formulae, R³ is a divalent molecular chain; however, it may be a trivalent or higher chain in which at least one hydrogen atom is substituted with —NH—CO—, —CO—, —O—, —NH—, or —N<.

Examples of the polybutadiene chain and the polyisoprene chain, which can be adopted as R³, include known chains respectively consisting of polybutadiene and polyisoprene as long as they satisfy the mass average molecular weight or the like. Both the polybutadiene chain and the polyisoprene chain are diene polymers having double bonds in the main chain; however, in the present invention, they include a polymer in which double bonds are hydrogenated (reduced) (for example, a non-diene polymer which does not have double bonds in the main chain). In the present invention, a hydride of a polybutadiene chain or polyisoprene chain is preferable.

The polybutadiene chain and the polyisoprene chain preferably have a reactive group at the terminal thereof as a raw material compound, and more preferably have a polymerizable terminal reactive group. The polymerizable terminal reactive group forms a group that is bonded to R³ of each of the above formulae by polymerization. Examples of the terminal reactive group include a hydroxy group, a carboxy group, and an amino group. In particular, a hydroxy group is preferable. As the polybutadiene and the polyisoprene, which have a terminal reactive group, for example as product names, NISSO-PB series (manufactured by NIPPON SODA Co., Ltd.), Krasol series (manufactured by TOMOE Engineering Co., Ltd.), PolyVEST-HT series (manufactured by Evonik Industries AG), Poly-bd series (manufactured by Idemitsu Kosan Co., Ltd.), Poly-ip series (manufactured by Idemitsu Kosan Co., Ltd.), and EPOL (manufactured by Idemitsu Kosan Co., Ltd.) are suitably used.

It is preferable that in the chain that can be adopted as R³, the mass average molecular weight or the like (in terms of polystyrene conversion) is 500 to 200,000. The lower limit thereof is preferably 500 or more, more preferably 700 or more, and still more preferably 1,000 or more. The upper limit thereof is preferably 100,000 or less and more preferably 10,000 or less. The mass average molecular weight or the like is measured by a method described later using a raw material compound before being incorporated into the main chain of the polymer.

The content of the constitutional component represented by any one of Formulae (1-1) to (1-5) in the polymer is not particularly limited; however, it is preferably 10% to 100% by mole. In terms of dispersion stability, bonding property, and the like, the content of the constitutional component represented by Formula (1-1) is more preferably 30% to 98% by mole and still more preferably 50% to 95% by mole. In terms of dispersion stability and the like, the content of the constitutional component represented by any one of Formulae (1-2) to (1-5) is more preferably 30% to 98% by mole and still more preferably 50% to 95% by mole. On the other hand, in terms of the improvement of bonding property, it is preferably 0% to 90% by mole, more preferably 10% to 80% by mole, and still more preferably 20% to 70% by mole.

(Constitutional Component Having Functional Group Selected from Group (a) of Functional Groups)

It is preferable that a polymer that forms at least one of the polymer binder A or the polymer binder B contains a constitutional component having as a substituent, for example, a functional group selected from the following group (a) of functional groups. Among the above, the polymer that forms the polymer binder B preferably contains a constitutional component having a functional group selected from the following group (a) of functional groups. The constitutional component having a functional group has a function of improving the adsorption rate of the binder and may be any constitutional component that forms the polymer. The functional group may be incorporated into the main chain or the side chain of the polymer. In the case of being incorporated into the side chain, the functional group may be directly bonded to the main chain or may be bonded through the above-described linking group. The linking group is not particularly limited; however, examples thereof include a linking group described later.

### <Group (a) of Functional Groups>

A hydroxy group, an amino group, a carboxy group, a sulfo group, a phosphate group, a phosphonate group, a sulfanyl group, an ether bond (—O—), an imino group (═NR, or —NR—), an ester bond (—CO—O—), an amide bond (—CO—NR—), an imide group (—CO—NR—CO—), a urethane bond (—NR—CO—O—), a urea bond (—NR—CO—NR—), a heterocyclic group, an aryl group, and a carboxylic acid anhydride group.

The group (a) of functional groups is preferably a group consisting of a hydroxy group, an amino group, a carboxy group, a sulfo group, a phosphate group, a phosphonate group, a sulfanyl group, an ether bond, an imino group, an amide bond, an imide group, a urethane bond, a urea bond, a heterocyclic group, an aryl group, and a carboxylic acid anhydride group.

Each of the amino group, the sulfo group, the phosphate group (the phosphoryl group), the heterocyclic group, and the aryl group, which are included in the group (a) of functional groups, is not particularly limited; however, it has the same meaning as the corresponding group of the substituent Z described later. However, the amino group more preferably has 0 to 12 carbon atoms, still more preferably 0 to 6 carbon atoms, and particularly preferably 0 to 2 carbon atoms. The phosphonate group is not particularly limited; however, examples thereof include a phosphonate group having 0 to 20 carbon atoms. In a case where a ring structure contains an amino group, an ether bond, an imino group (—NR—), an ester bond, an amide bond, an imide group, a urethane bond, a urea bond, or the like, it is classified as a heterocyclic ring. The heterocyclic ring containing an imide group in the ring structure is not particularly limited. However, examples thereof include an carboxylic acid anhydride group described later, for example, a ring obtained by changing the “—CO—O—CO—” group in Formula (2a) or Formula (2b) to a “—CO—NR^{I}—CO—” group Here, RI represents a hydrogen atom or a substituent. The substituent is not particularly limited. It is selected from a substituent Z described later, and an alkyl group is preferable. The hydroxy group, the amino group, the carboxy group, the sulfo group, the phosphate group, the phosphonate group, or the sulfanyl group may form a salt.

R in each bond represents a hydrogen atom or a substituent, and it is preferably a hydrogen atom. The substituent is not particularly limited. It is selected from a substituent Z described later, and an alkyl group is preferable.

R^{I} in the imide group is as described above.

The carboxylic acid anhydride group is not particularly limited; however, it includes a group obtained by removing one or more hydrogen atoms from a carboxylic acid anhydride (for example, a group represented by Formula (2a)), as well as a constitutional component itself (for example, a constitutional component represented by Formula (2b)) obtained by copolymerizing a polymerizable carboxylic acid anhydride as a copolymerizable compound. The group obtained by removing one or more hydrogen atoms from a carboxylic acid anhydride is preferably a group obtained by removing one or more hydrogen atoms from a cyclic carboxylic acid anhydride. The carboxylic acid anhydride group derived from a cyclic carboxylic acid anhydride also corresponds to a heterocyclic group; however, it is classified as a carboxylic acid anhydride group in the present invention. Examples thereof include acyclic carboxylic acid anhydrides such as acetic acid anhydride, propionic acid anhydride, and benzoic acid anhydride, and cyclic carboxylic acid anhydrides such as maleic acid anhydride, phthalic acid anhydride, fumaric acid anhydride, and succinic acid anhydride. The polymerizable carboxylic acid anhydride is not particularly limited; however, examples thereof include a carboxylic acid anhydride having an unsaturated bond in the molecule, and a polymerizable cyclic carboxylic acid anhydride is preferable. Specific examples thereof include maleic acid anhydride.

Examples of the carboxylic acid anhydride group include a group represented by Formula (2a) and a constitutional component represented by Formula (2b); however, the present invention is not limited thereto. In each of the formulae, * represents a bonding position.

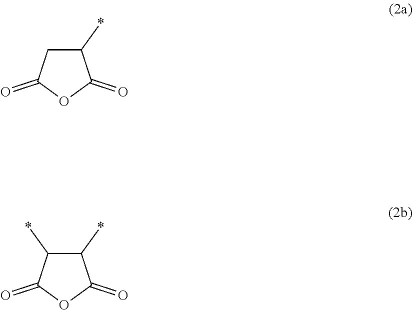 [SMILES: *C1CC(=O)OC1=O ; *C1C(=O)OC(=O)C1*]

In the sequential polymerization polymer, the ester bond (—CO—O—), the amide bond (—CO—NR—), the urethane bond (—NR—CO—O—), and the urea bond (—NR—CO—NR—) are represented by being divided into, a —CO— group and a —O— group, a —CO group and a —NR— group, a —NR—CO— group and a —O— group, and an —NR—CO— group and a —NR— group, respectively, in a case where the chemical structure of the polymer is represented by constitutional components derived from raw material compounds. As a result, in the present invention, the constitutional components having these bonds are regarded as constitutional components derived from the carboxylic acid compound or constitutional components derived from the isocyanate compound regardless of the notation of the polymer, and they do not include constitutional components derived from the polyol or polyamine compound.

In addition, in the chain polymerization polymer, the constitutional component having an ester bond (excluding an ester bond that forms a carboxy group) means a constitutional component in which an ester bond is not directly bonded to an atom that constitutes the main chain of a chain polymerization polymer or the main chain of a polymerized chain (for example, a polymerized chain contained in a macromonomer) that is incorporated into the chain polymerization polymer as a branched chain or a pendant chain, and it does not include, for example, a constitutional component derived from a (meth)acrylic acid alkyl ester.

In the present invention, an aspect in which the amino group, the ether bond, the imino group, the ester bond, the amide bond, the urethane bond, the urea bond, the heterocyclic group, and the aryl group are incorporated into a branched chain of the polymer is preferable.

The functional group contained in one constitutional component may be one kind or two or more kinds, and in a case where two or more kinds are contained, they may be bonded or may not be bonded to each other. In addition, the number of functional groups contained in one constitutional component is not particularly limited and may be 1 or more, and it can be set to 1 to 4.

The linking group that binds a functional group to the main chain is not particularly limited; however, except for the particularly preferred linking group, it has the same meaning as the linking group in the group having a hydrocarbon group having 4 or more carbon atoms, which can be adopted as R² of Formula (1-1). As the linking group that binds a functional group to the main chain, a particularly preferred linking group is a group obtained by combining a —CO—O— group or —CO—N(R^{N})— group (here, R^{N} is as described above) and an alkylene group or polyalkyleneoxy chain.

The constitutional component having the above-described functional group is not particularly limited as long as it has the above functional group. However, examples thereof include a constitutional component into which the above functional group is introduced into a constitutional component represented by any one of Formula (1-1) to Formula (1-5), a constitutional component into which the above functional group is introduced into a constitutional component represented by Formula (I-1) or Formula (I-2) described later, into a constitutional component derived from a compound represented by Formula (I-5) described later, into a constitutional component represented by Formula (I-3) or Formula (I-4) described later, or into a constitutional component derived from a compound represented by Formula (I-6), and furthermore, a constitutional component into which the above functional group is introduced into a (meth)acrylic compound (M1) or another polymerizable compound (M2) described later or into a constitutional component represented by any one of Formula (b-1) to Formula (b-3) described later.

The compound from which the constitutional component having the above-described functional group is derived is not particularly limited; however, examples thereof include a compound in which the above functional group is introduced into a (meth)acrylic acid short-chain alkyl ester compound (here, short-chain alkyl means an alkyl group having 3 or less of carbon atoms).

The content of the constitutional component having the above-described functional group in the polymer is not particularly limited.

The content thereof in the sequential polymerization polymer is preferably 0.01% to 50% by mole, more preferably 0.1% to 50% by mole, and still more preferably 0.3% to 50% by mole, in terms of the dispersion characteristics, the bonding property, and the like of the solid particles. The content thereof in the chain polymerization polymer is preferably 0.01% to 80% by mole, more preferably 0.01% to 70% by mole, still more preferably 0.1% to 50% by mole, and particularly preferably 0.3% to 50% by mole, in terms of the dispersion characteristics, the bonding property, and the like of the solid particles. The upper limit value of the content can be set to 30% by mole or less or 10% by mole or less. In the sequential polymerization polymer and the chain polymerization polymer, the lower limit value of the content can be set to 1 mole or more, 5% by mole or more, or 20% by mole or more.

### —Sequential Polymerization Polymer—

The sequential polymerization polymer as a polymer that forms the above-described binder preferably has a constitutional component having a functional group selected from the Group (a) of functional groups described above or a constitutional component represented by any one of Formula (1-2) to Formula (1-5), and furthermore, it may have a constitutional component different from these constitutional components. Among the constitutional components shown below, the constitutional component represented by Formula (I-1) or Formula (I-2) and the constitutional component derived from the compound represented by Formula (I-5) correspond to the constitutional component having a functional group selected from the Group (a) of functional groups; however, they will be described together with other constitutional components. Examples of the other constitutional components include a constitutional component represented by Formula (I-1) or (I-2) and furthermore, a constitutional component obtained by sequentially polymerizing one or more kinds (preferably 1 to 8 kinds and more preferably 1 to 4 kinds) of constitutional components represented by Formula (I-3) or (I-4) or a carboxylic acid dianhydride represented by Formula (I-5) with a diamine compound from which a constitutional component represented by Formula (I-6) is derived. The combination of each of the constitutional components is appropriately selected depending on the kind of polymer. One kind of constitutional component that is used in the combination of the constitutional components refers to the constitutional component represented by any one of the following formulae. Even in a case where two kinds of constitutional components represented by one of the following formulae are contained, it is not interpreted as two constitutional components.

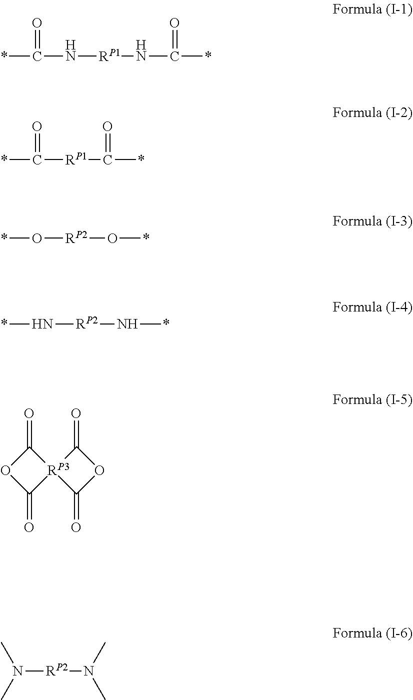

In the formulae, R^{P1} and R^{P2} each independently represent a molecular chain having a (mass-average) molecular weight of 20 to 200,000. The molecular weight of the molecular chain cannot be unambiguously determined because it depends on the kind thereof and the like, and is, for example, preferably 30 or higher, more preferably 50 or higher, still more preferably 100 or higher, and still more preferably 150 or higher. The upper limit thereof is preferably 100,000 or less and more preferably 10,000 or less. The molecular weight of the molecular chain is measured for a raw material compound before being incorporated into the main chain of the polymer.

The molecular chain which can be adopted as R^{P1} and R^{P2} is not particularly limited and is preferably a hydrocarbon chain, a polyalkylene oxide chain, a polycarbonate chain, or a polyester chain, more preferably a hydrocarbon chain or a polyalkylene oxide chain, and still more preferably a hydrocarbon chain, a polyethylene oxide chain, or a polypropylene oxide chain.

The hydrocarbon chain which can be adopted as R^{P1} and R^{P2} means a chain of hydrocarbon including a carbon atom and a hydrogen atom, and more specifically means a structure in which at least two atoms (for example, hydrogen atoms) or a group (for example, a methyl group) is desorbed from the compound including a carbon atom and a hydrogen atom. However, in the present invention, the hydrocarbon chain also includes a chain that includes a group having an oxygen atom, a sulfur atom, or a nitrogen atom in the chain, for example, as in a hydrocarbon group represented by Formula (M2). A terminal group that may be present in a terminal of the hydrocarbon chain is not included in the hydrocarbon chain. This hydrocarbon chain may include a carbon-carbon unsaturated bond or may include a ring structure of an aliphatic ring and/or an aromatic ring. That is, the hydrocarbon chain may be a hydrocarbon chain including a hydrocarbon selected from an aliphatic hydrocarbon or an aromatic hydrocarbon.

It suffices that such a hydrocarbon chain satisfies the above molecular weight, and the hydrocarbon chain includes a double hydrocarbon chain including a chain consisting of a hydrocarbon group having a low molecular weight and a hydrocarbon chain (also referred to as the “hydrocarbon polymer chain”) consisting of a hydrocarbon polymer.

The hydrocarbon chain having a low molecular weight is a chain consisting of a typical (non-polymerizable) hydrocarbon group, and examples of the hydrocarbon group include an aliphatic or aromatic hydrocarbon group. Specifically, an alkylene group (having preferably 1 to 12 carbon atoms, more preferably 1 to 6 carbon atoms, and still more preferably 1 to 3 carbon atoms), an arylene group (having preferably 6 to 22 carbon atoms, more preferably 6 to 14 carbon atoms, and still more preferably 6 to 10 carbon atoms), or a group consisting of a combination of the above-described groups is preferable. As the hydrocarbon group that forms the hydrocarbon chain having a low molecular weight which can be adopted as R^{P2}, an alkylene group is more preferable, an alkylene group having 2 to 6 carbon atoms is still more preferable, and an alkylene group having 2 or 3 carbon atoms is still more preferable. This hydrocarbon chain may have a polymerized chain (for example, a (meth)acrylic polymer) as a substituent.

The aliphatic hydrocarbon group is not particularly limited, and examples thereof include a hydrogen reduced form of an aromatic hydrocarbon group represented by Formula (M2) and a partial structure (for example, a group consisting of isophorone) in a known aliphatic diisocyanate compound.

Examples of the aromatic hydrocarbon group include a hydrocarbon group contained in each of the exemplary constitutional components described below, and an arylene group (for example, a group obtained by removing one or more hydrogen atoms from the aryl group mentioned in the substituent Z described later; specifically, a phenylene group, a tolylene group, or a xylylene group) or a hydrocarbon group represented by Formula (M2) is preferable.

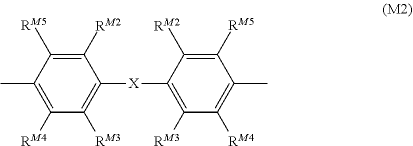

In Formula (M2), X represents a single bond, —CH₂—, —C(CH₃)₂—, —SO₂—, —S—, —CO—, or —O— and is preferably —CH₂— or —O—, and more preferably —CH₂— from the viewpoint of bonding property. The alkylene group and the methyl group, which are exemplified herein, may be substituted with a substituent Z and preferably a halogen atom (more preferably a fluorine atom).

R^{M2} to R^{M5} each independently represent a hydrogen atom or a substituent and preferably a hydrogen atom. The substituent which can be adopted as R^{M2} to R^{M5} is not particularly limited; however, examples thereof include an alkyl group having 1 to 20 carbon atoms, an alkenyl group having 1 to 20 carbon atoms, —OR^{M6}, —N(R^{M6})₂, —SR^{M6} (R^{M6} represents a substituent and preferably an alkyl group having 1 to 20 carbon atoms or an aryl group having 6 to 10 carbon atoms), and a halogen atom (for example, a fluorine atom, a chlorine atom, or a bromine atom). Examples of —N(R^{M6})₂ include an alkylamino group (having preferably 1 to 20 carbon atoms and more preferably 1 to 6 carbon atoms) and an arylamino group (having preferably 6 to 40 carbon atoms and more preferably 6 to 20 carbon atoms).

The hydrocarbon polymer chain is not particularly limited as long as it is a polymer chain obtained by polymerizing (at least two) polymerizable hydrocarbons and a chain consisting of a hydrocarbon polymer having a larger number of carbon atoms than the above-described hydrocarbon chain having a low molecular weight; however, it is preferably a chain consisting of a hydrocarbon polymer consisting of 30 or more carbon atoms and more preferably 50 or more carbon atoms. The upper limit of the number of carbon atoms that constitute the hydrocarbon polymer is not particularly limited and may be, for example, 3,000. The hydrocarbon polymer chain is preferably a chain consisting of a hydrocarbon polymer composed of an aliphatic hydrocarbon in which the main chain satisfies the above-described number of carbon atoms and more preferably a chain consisting of a polymer (preferably an elastomer) composed of an aliphatic saturated hydrocarbon or an unsaturated aliphatic hydrocarbon. Specific examples of the polymer include a diene polymer having double bonds in the main chain and a non-diene polymer not having double bonds in the main chain. Examples of the diene polymer include a styrene-butadiene copolymer, a styrene-ethylene-butadiene copolymer, a copolymer (preferably butyl rubber (IIR)) of isobutylene and isoprene, and an ethylene-propylene-diene copolymer. Examples of the non-diene polymer include an olefin polymer such as an ethylene-propylene copolymer or a styrene-ethylene-butylene copolymer and a hydrogen reduced form of the above-described diene polymer.

The hydrocarbon forming the hydrocarbon chain preferably has a reactive group at a terminal and more preferably has a terminal reactive group capable of polycondensation. The terminal reactive group capable of polycondensation or polyaddition forms a group bonded to R^{P1} or R^{P2} in each of the formulae by polycondensation or polyaddition. Examples of the terminal reactive group include an isocyanate group, a hydroxy group, a carboxy group, an amino group, and an acid anhydride. In particular, a hydroxy group is preferable.

As the hydrocarbon polymer having a terminal reactive group, for example as product names, NISSO-PB series (manufactured by NIPPON SODA Co., Ltd.), Krasol series (manufactured by TOMOE Engineering Co., Ltd.), PolyVEST-HT series (manufactured by Evonik Industries AG), Poly-bd series (manufactured by Idemitsu Kosan Co., Ltd.), Poly-ip series (manufactured by Idemitsu Kosan Co., Ltd.), EPOL (manufactured by Idemitsu Kosan Co., Ltd.), and POLYTAIL series (manufactured by Mitsubishi Chemical Corporation) are suitably used.

Examples of the polyalkylene oxide chain (the polyalkyleneoxy chain) include a chain consisting of a known polyalkyleneoxy group. The number of carbon atoms in the alkyleneoxy group of the polyalkyleneoxy chain is preferably 1 to 10, more preferably 1 to 6, and still more preferably 2 or 3 (a polyethyleneoxy chain or a polypropyleneoxy chain). The polyalkyleneoxy chain may be a chain consisting of one alkyleneoxy group or may be a chain consisting of two or more alkyleneoxy groups (for example, a chain consisting of an ethyleneoxy group and a propyleneoxy group).

Examples of the polycarbonate chain or the polyester chain include a chain consisting of a known polycarbonate or polyester.

It is preferable that the polyalkyleneoxy chain, the polycarbonate chain, or the polyester chain includes an alkyl group (having preferably 1 to 12 carbon atoms and more preferably 1 to 6 carbon atoms) at a terminal.

The terminal of the polyalkyleneoxy chain, the polycarbonate chain, or the polyester chain, which can be adopted as R^{P1} and R^{P2}, can be appropriately changed to a typical chemical structure that can be incorporated into the constitutional component represented by each of the formulae as R^{P1} and R^{P2}. For example, a polyalkyleneoxy chain from which the terminal oxygen atom has been removed is incorporated as R^{P1} or R^{P2} of the above constitutional component.

In the alkyl group in the molecular chain or at a terminal thereof, an ether group (—O—), a thioether group (—S—), a carbonyl group (>C═O), or an imino group (>NR^{N}. R^{N} represents a hydrogen atom, an alkyl group having 1 to 6 carbon atoms, or an aryl group having 6 to 10 carbon atoms) may be present.

In each of the formulae, R^{P1} and R^{P2} represent a divalent molecular chain but may represent a trivalent or higher molecular chain in which at least one hydrogen atom is substituted with —NH—CO—, —CO—, —O—, —NH—, or —N<.

Among the above molecular chains, R^{P1} is preferably a hydrocarbon chain, more preferably a hydrocarbon chain having a low molecular weight, still more preferably a hydrocarbon chain consisting of an aliphatic or aromatic hydrocarbon group, and particularly preferably a hydrocarbon chain consisting of an aliphatic hydrocarbon group.

Among the above molecular chains, RP² is preferably a low molecular weight hydrocarbon chain (more preferably an aliphatic hydrocarbon group) or a molecular chain other than the hydrocarbon chain having a low molecular weight (more preferably, a polyalkylene oxide chain).

Specific examples of the constitutional component represented by Formula (I-1) are shown below and in Examples and the like. Examples of the raw material compound (the diisocyanate compound) from which the constitutional component represented by Formula (I-1) is derived include the diisocyanate compound represented by Formula (M1) described in WO2018/020827A and the specific example thereof and further include a polymeric 4,4′-diphenylmethane diisocyanate. In the present invention, the constitutional component represented by Formula (I-1) and the raw material compound derived from the constitutional component are not limited to those described in the following specific examples, Examples, and the above documents.

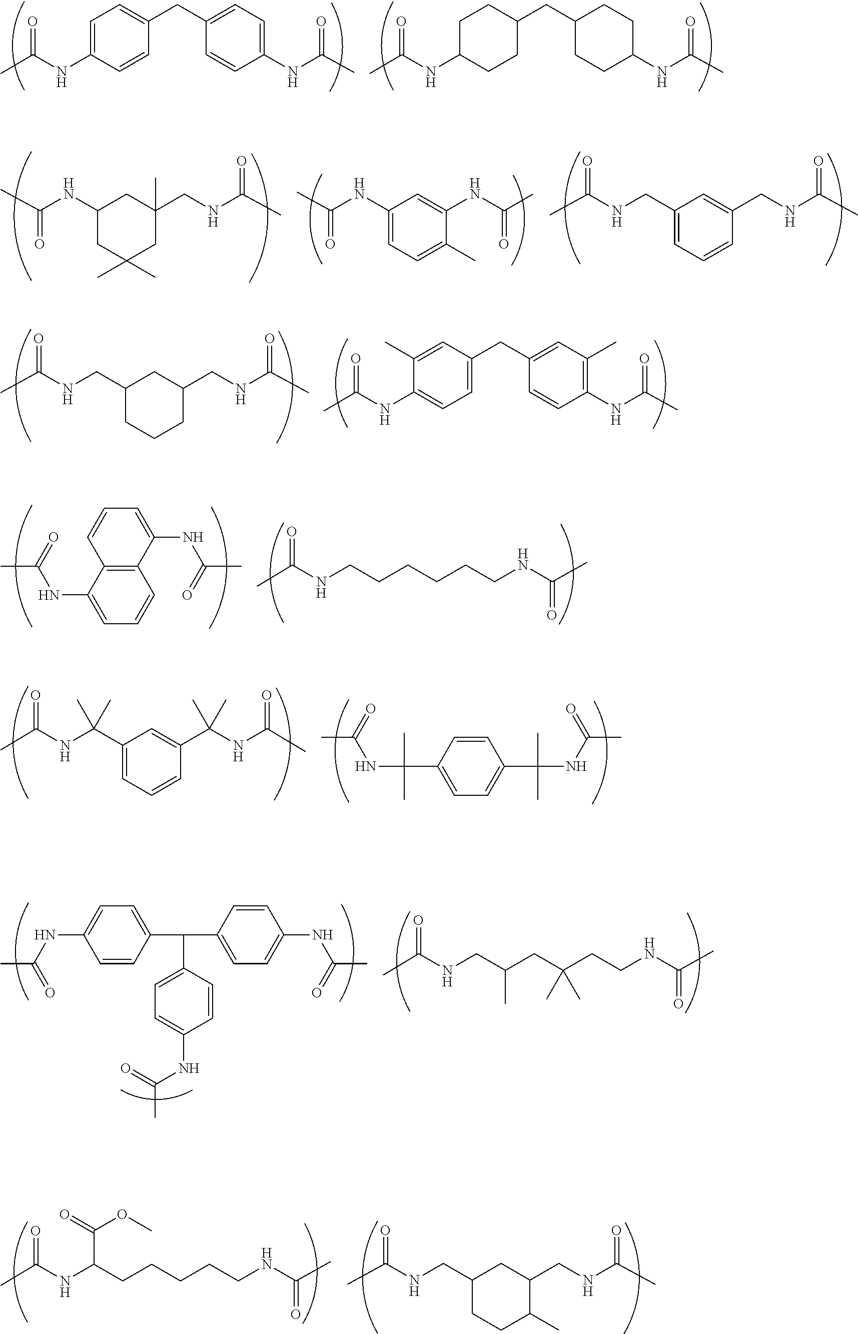

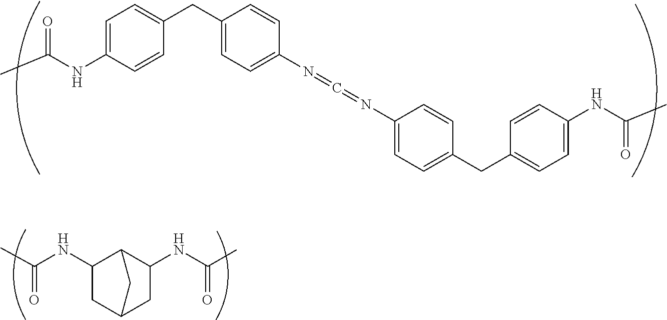

The raw material compound (a carboxylic acid, an acid chloride thereof, or the like) from which the constitutional components represented by Formula (I-2) are derived is not particularly limited, and examples of the raw material compound include the carboxylic acid or the compound of the acid chloride, and the specific examples thereof (for example, adipic acid or an esterified product thereof), which are described in paragraph [0074] of WO2018/020827A.

Specific examples of the constitutional components represented by Formula (I-3) or Formula (I-4) are shown below and in Examples. The raw material compound (the diol compound or the diamine compound) from which the constitutional component represented by Formula (I-3) or Formula (I-4) is derived is not particularly limited. Examples thereof include the respective compounds and the specific examples thereof, which are described in WO2018/020827A, and further include dihydroxyoxamide. In the present invention, the constitutional components represented by Formula (I-31 or Formula (I-41 and the raw material compounds from which the compounds are derived are not limited to those described in the following specific examples, the exemplary polymer described later, and those in Examples and the above documents.

In the following specific examples, in a case where the constitutional component has a repeating structure, the repetition number is an integer of 1 or more and is appropriately set within a range that satisfies the molecular weight or the number of carbon atoms of the molecular chain.

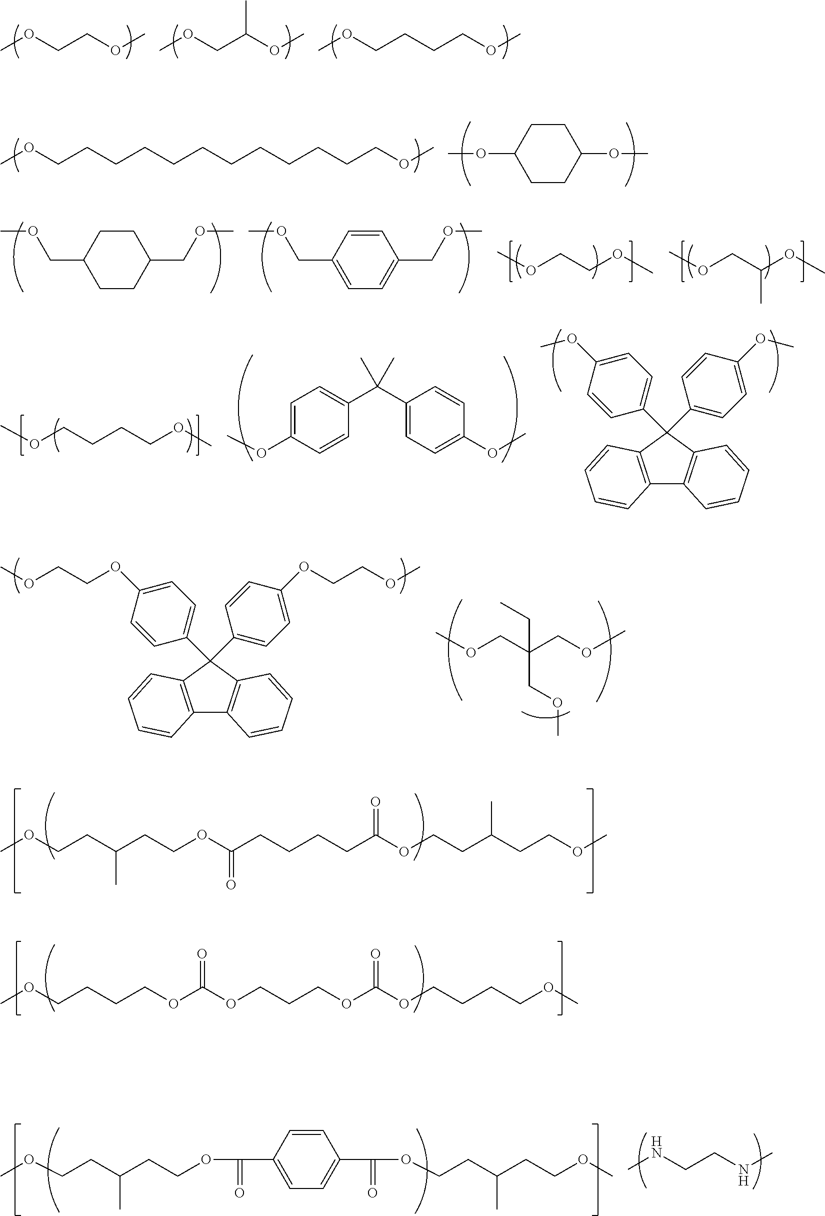

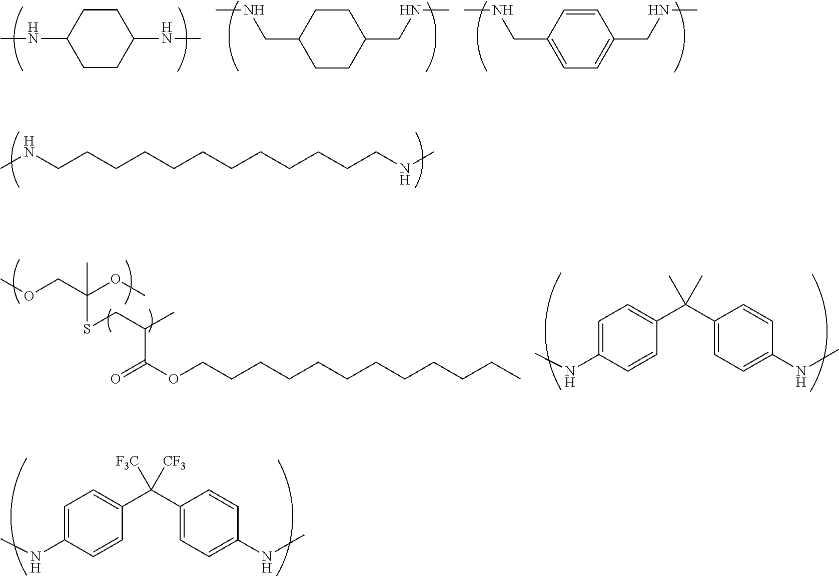

In Formula (I-5), R^{P3} represents an aromatic or aliphatic linking group (tetravalent) and preferably a linking group represented by any one of Formulae (i) to (iix).

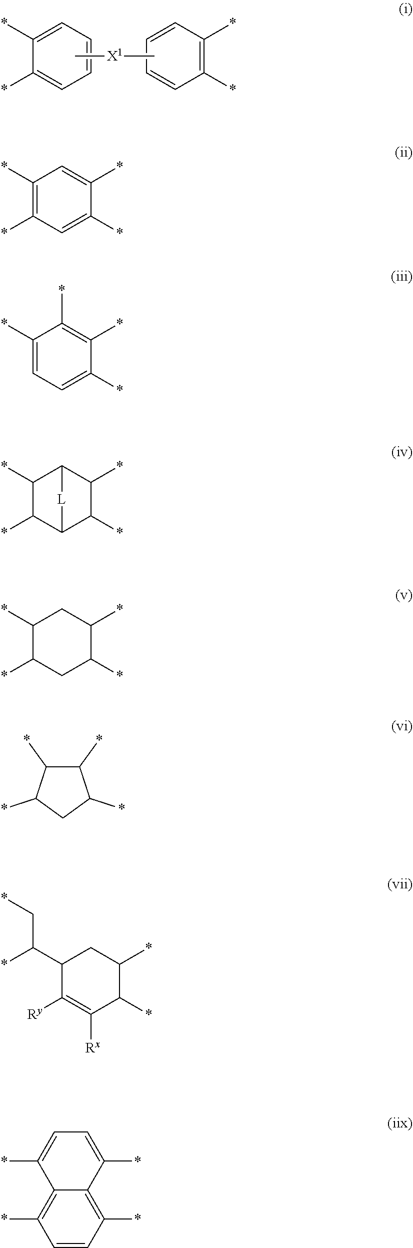

In Formulae (i) to (iix), X¹ represents a single bond or a divalent linking group. As the divalent linking group, an alkylene group having 1 to 6 carbon atoms (for example, methylene, ethylene, or propylene) is preferable. The propylene is preferably 1,3-hexafluoro-2,2-propanediyl. L represents —CH₂═CH₂— or —CH₂—. R^{X} and R^{Y} each independently represent a hydrogen atom or a substituent. In each of the formulae, * represents a binding portion to the carbonyl group in Formula (I-5). The substituent that can be adopted as R^{X} and R^{Y} is not particularly limited, and examples thereof include the substituent Z described below. In particular, an alkyl group (having preferably 1 to 12 carbon atoms, more preferably 1 to 6 carbon atoms, still more preferably 1 to 3 carbon atoms) or an aryl group (having preferably 6 to 22 carbon atoms, more preferably 6 to 14 carbon atoms, still more preferably 6 to 10 carbon atoms) is preferable.

The carboxylic acid dianhydride represented by Formula (I-5) and the raw material compound (the diamine compound) from which the constitutional components represented by Formula (I-6) are respectively derived are not particularly limited, and examples thereof include the respective compounds and the specific examples thereof, which are described in WO2018/020827A and WO2015/046313A.

R^{P1}, R^{P2}, and R^{P3} may each independently have a substituent. The substituent is not particularly limited, and examples thereof include the substituent Z described below or each group included in the Group (a) of functional groups described above. In particular, suitable examples thereof include the substituent that can be adopted as R^{M2}.

In a case where the polymer that forms the above-described binder is a sequential polymerization polymer, it may have a constitutional component represented by any one of Formulae (1-1) to (1-5) described above, preferably a constitutional component having a functional group selected from the Group (a) of functional groups (including a constitutional component represented by Formula (I-1)), and may further have a constitutional component represented by Formula (I-3), formula (I-4), or formula (I-5). Examples of the constitutional component represented by Formula (I-3) include a constitutional component represented by at least one of Formula (I-3A) to Formula (I-3C). The case of the constitutional component represented by Formula (I-3) applies similarly to the constitutional component represented by Formula (I-4) as well; however, in each of Formula (I-3A) to Formula (I-3C), the oxygen atom is substituted with a nitrogen atom.

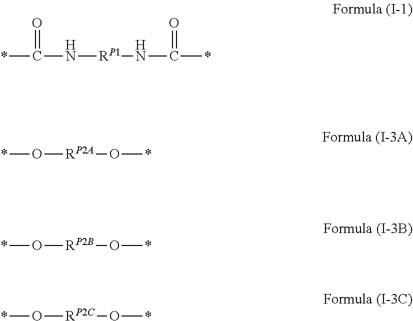

In Formula (I-1), R^{P1} is as described above. In formula (I-3A), R^{P2A} represents a chain consisting of a hydrocarbon group having a low molecular weight (preferably, an aliphatic hydrocarbon group). In Formula (I-3B), R^{P2B} represents a polyalkyleneoxy chain. In Formula (I-3C), R^{P2C} represents a hydrocarbon polymer chain. The chain consisting of a hydrocarbon group having a low molecular weight, which can be adopted as R^{P2A}, the polyalkyleneoxy chain which can be adopted as R^{P2C}, and the hydrocarbon polymer chain which can be adopted as R^{P2B} are respectively the same as the aliphatic hydrocarbon group, the polyalkyleneoxy chain, and the hydrocarbon polymer chain, each of which can be adopted as R^{P2} in Formula (I-3), and the same is applied to the preferred ones thereof.

The polymer (sequential polymerization polymer) that forms the above-described binder may have a constitutional component other than the constitutional component represented by the above formulae. Such a constitutional component is not particularly limited as long as it can be subjected to sequential polymerization with a raw material compound from which the constitutional component represented by each of the above formulae is derived.

In the polymer that forms the above-described binder, the (total) content of the constitutional components represented by Formula (I-1) to Formula (I-6) is not particularly limited; however, it is preferably 5% to 100% by mole, more preferably 5% to 80% by mole, and still more preferably 10% to 60% by mole. The upper limit value of the content thereof may be, for example, 100% by mole or less regardless of the above 60% by mole.

In the polymer that forms the above-described binder, the content of the constitutional component other than the constitutional component represented by each of the above formulae is not particularly limited; however, it is preferably 50% by mole or less.

In a case where the polymer that forms the above-described binder has a constitutional component represented by any of Formula (I-1) to Formula (I-6), the content thereof is not particularly limited, and it can be appropriately selected. For example, it can be set in the following range.

That is, in the polymer that forms the above-described binder, the content of the constitutional component represented by Formula (I-1) or Formula (I-2) or the constitutional component derived from the carboxylic acid dianhydride represented by Formula (I-5) is not particularly limited; however, it is preferably the same as the above-described content of the constitutional component having a functional group.

In the polymer that forms the above-described binder, the content of the constitutional component represented by Formula (I-3), Formula (I-4), or Formula (I-6) is not particularly limited, and it is preferably 1% to 80% by mole, more preferably 10% to 80% by mole, still more preferably 20% to 70% by mole, and particularly preferably 30% to 60% by mole.

The content of each constitutional component represented by any one of Formula (I-3A) to Formula (I-3C) can be appropriately set in consideration of the content of each constitutional component represented by Formula (I-3).

It is noted that in a case where the polymer that forms the above-described binder has a plurality of constitutional components represented by the respective formulae, the above-described content of each of the constitutional components shall be in terms of the total content thereof.

The polymer (each constitutional component and raw material compound) that forms the above-described binder may have a substituent. The substituent is not particularly limited; however, examples thereof preferably include a group selected from the following substituent Z.

The polymer that forms the above-described binder can be synthesized with a known method by selecting a raw material compound depending on the kind of bond of the main chain and subjecting the raw material compound to polyaddition or polycondensation. As the synthesis method, for example, WO2018/151118A can be referenced.

The method of incorporating a functional group is not particularly limited, and examples thereof include a method of copolymerizing a compound having a functional group selected from the Group (a) of functional groups, a method of using a polymerization initiator having (generating) the above functional group, and a method of using a polymeric reaction.

Examples of each of the polymers of polyurethane, polyurea, polyamide, and polyimide which can be adopted as the polymer that forms the binder include, in addition to the exemplary polymer described later and those synthesized in Examples, each of the polymers described in WO2018/020827A and WO2015/046313A and further include each of the polymers described in JP2015-088480A.

### —Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, andoleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present invention, the alkyl group generally has a meaning including a cycloalkyl group therein in a case of being referred to, however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which an —O—CO— group is bonded to the above-described heterocyclic group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, or a nicotinoyloxy group); an aryloyloxy group (preferably an aryloyloxy group having 7 to 23 carbon atoms, for example, a benzoyloxy group or a naphthoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group); an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group); an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group); an aryloxysilyl group (preferably an aryloxysilyl group having 6 to 42 carbon atoms, for example, a triphenyloxysilyl group), a phosphoryl group (preferably a phosphate group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a phosphonate group (preferably a phosphonate group having 0 to 20 carbon atoms, for example, —PO(ORP)₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

### —Chain Polymerization Polymer—

The chain polymerization polymer as a polymer that forms the above-described binder will be described.

The chain polymerization polymer preferably has the above-described constitutional component having a functional group selected from the Group (a) of functional groups or the above-described constitutional component represented by Formula (1-1) and more preferably has the constitutional component having the above-described functional group and the constitutional component represented by Formula (1-1), and further, it may have a constitutional component different from these constitutional components. The chain polymerization polymer may not have the constitutional component having a functional group selected from the Group (a) of functional groups or the above-described constitutional component represented by Formula (1-1) and may be a polymer consisting of another constitutional component.

Examples of the fluorine-containing polymer include polytetrafluoroethylene (PTFE), polyvinylidene difluoride (PVdF), a copolymer of polyvinylidene difluoride and hexafluoropropylene (PVdF-HFP), and a copolymer (PVdF-HFP-TFE) of polyvinylidene difluoride, hexafluoropropylene, and tetrafluoroethylene. In PVdF-HFP, the copolymerization ratio [PVdF:HFP] (mass ratio) of PVdF to HFP is not particularly limited; however, it is preferably 9:1 to 5:5 and more preferably 9:1 to 7:3 from the viewpoint of adhesiveness. In PVdF-HFP-TFE, the copolymerization ratio [PVdF:HFP:TFE] (mass ratio) of PVdF, HFP, and TFE is not particularly limited; however, it is preferably 20 to 60:10 to 40:5 to 30, and more preferably 25 to 50:10 to 35:10 to 25.

Examples of the hydrocarbon polymer include polyethylene, polypropylene, natural rubber, polybutadiene, polyisoprene, polystyrene, a polystyrene butadiene copolymer, a styrene-based thermoplastic elastomer, polybutylene, an acrylonitrile butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and furthermore, a random copolymer corresponding to each of the above-described block copolymers such as SEBS. In the present invention, the hydrocarbon polymer preferably has no unsaturated group (for example, a 1,2-butadiene constitutional component) that is bonded to the main chain from the viewpoint that the formation of chemical crosslink can be suppressed.

Examples of the vinyl polymer include a polymer containing a vinyl monomer other than the (meth)acrylic compound (M1), where the content of the vinyl polymer is, for example, 50% by mole or more. Examples of the vinyl monomer include vinyl compounds described later. Specific examples of the vinyl polymer include polyvinyl alcohol, polyvinyl acetal, polyvinyl acetate, and a copolymer containing these.

In addition to the constitutional component derived from the vinyl monomer, this vinyl polymer preferably has a constitutional component derived from the (meth)acrylic compound (M1) that forms a (meth)acrylic polymer described later. The content of the constitutional component derived from the vinyl monomer is preferably the same as the content of the constitutional component derived from the (meth)acrylic compound (M1) in the (meth)acrylic polymer. The content of the constitutional component derived from the (meth)acrylic compound (M1) in the polymer is not particularly limited as long as it is less than 50% by mole; however, it is preferably 0% to 30% by mole.

The (meth)acrylic polymer is preferably, as another constitutional component, a polymer obtained by copolymerizing at least one (meth)acrylic compound (M1) selected from a (meth)acrylic acid compound, a (meth)acrylic acid ester compound, a (meth)acrylamide compound, or a (meth)acrylonitrile compound. Further, a (meth)acrylic polymer consisting of a copolymer of the (meth)acrylic compound (M1) and another polymerizable compound (M2) is also preferable. The other polymerizable compound (M2) is not particularly limited, and examples thereof include vinyl compounds such as a styrene compound, a vinyl naphthalene compound, a vinyl carbazole compound, an allyl compound, a vinyl ether compound, a vinyl ester compound, a dialkyl itaconate compound, and an unsaturated carboxylic acid anhydride, and fluorinated compounds thereof. Examples of the vinyl compound include the “vinyl-based monomer” disclosed in JP2015-88486A.

The (meth)acrylic compound (M1) and another polymerizable compound (M2) may have a substituent. The substituent is not particularly limited as long as it is a group other than the functional group included in the above-described group (a) of functional groups, and preferred examples thereof include a group selected from the substituent Z described above.

The content of the other polymerizable compound (M2) in the (meth)acrylic polymer is not particularly limited; however, it can be, for example, 50% by mole or less.

The (meth)acrylic compound (M1) and the vinyl compound (M2), from which the constitutional components of the (meth)acrylic polymer and the vinyl polymer are derived, are preferably a compound represented by Formula (b-1). This compound is different from the constitutional component having a functional group included in the above-described Group (a) of functional groups and the compound from which the constitutional component represented by Formula (1-1) is derived.

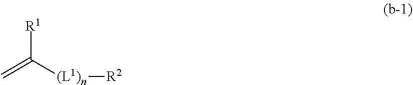

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited. However, examples thereof include an alkyl group (preferably a linear chain although it may be a branched chain), an alkenyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 14 carbon atoms), an aralkyl group (preferably having 7 to 23 carbon atoms and more preferably 7 to 15 carbon atoms), and a cyano group.

The alkyl group preferably has 1 to 3 carbon atoms. The alkyl group may have, for example, a group other than the functional group included in the group (a) of functional groups, among the above-described substituent Z.

L¹ is a linking group and is not particularly limited. However, examples thereof include an alkylene group having 1 to 6 carbon atoms (preferably 1 to 3 carbon atoms), an alkenylene group having 2 to 6 carbon atoms (preferably 2 or 3 carbon atoms), an arylene group having 6 to 24 carbon atoms (preferably 6 to 10 carbon atoms), an oxygen atom, a sulfur atom, an imino group (—NR^{N}—. here, R^{N} is as described above), a carbonyl group, and a phosphate linking group (—O—P(OH)(O)—O—), a phosphonate linking group (—P(OH)(O)—O—), and a group involved in the combination thereof, and a —CO—O— group or a —CO—N(R^{N})— group (R^{N} is as described above) is preferable. The above linking group may have any substituent. The number of atoms that constitute the linking group and the number of linking atoms are as described later. Examples of any substituent include a substituent Z described above, and examples thereof include an alkyl group and a halogen atom.

n is 0 or 1 and preferably 1. However, in a case where-(L¹)ₙ-R² represents one kind of substituent (for example, an alkyl group), n is set to 0, and R² is set to a substituent (an alkyl group).

Examples of the preferred (meth)acrylic compound (M1) include a compound represented by Formula (b-2) or (b-3). This compound is different from the constitutional component having a functional group included in the above-described Group (a) of functional groups and the compound from which the constitutional component represented by Formula (1-1) is derived.

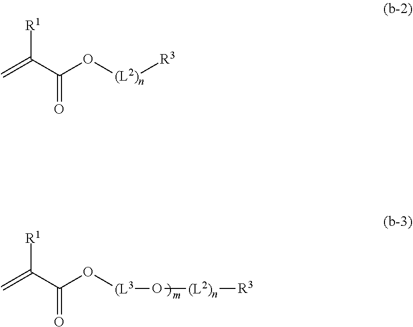

R¹ and n respectively have the same meanings as those in Formula (b-1).
R³ has the same meaning as R².
L² is a linking group and has the same meaning as the above L¹.
L³ is a linking group and has the same meaning as the above L¹; however, it is preferably an alkylene group having 1 to 6 carbon atoms (preferably 1 to 3 carbon atoms).
m is an integer of 1 to 200, and it is preferably an integer of 1 to 100 and more preferably an integer of 1 to 50.

In Formulae (b-1) to (b-3), the carbon atom which forms a polymerizable group and to which R¹ is not bonded is represented as an unsubstituted carbon atom (H₂C═); however, it may have a substituent. The substituent is not particularly limited; however, examples thereof include the above group that can be adopted as R¹.

Further, in Formulae (b-1) to (b-3), the group which may take a substituent such as an alkyl group, an aryl group, an alkylene group, or an arylene group may have a substituent within a range where the effect of the present invention is not impaired. It suffices that the substituent is a substituent other than the functional group selected from the Group (a) of functional groups. Examples thereof include a group selected from the substituent Z described later, and specific examples thereof include a halogen atom.

The (meth)acrylic polymer preferably has the above-described constitutional component having a functional group selected from the Group (a) of functional groups or the above-described constitutional component represented by Formula (1-1) and it can have a constitutional component derived from the (meth)acrylic compound (M1), a constitutional component derived from the vinyl compound (M2), and another constitutional component that is copolymerizable with a compound from which these constitutional components are derived. A case where the above-described constitutional component represented by Formula (1-1) and a constitutional component having a functional group selected from the group (a) of functional groups among the (meth)acrylic compounds (M1) is contained is preferable in terms of dispersion stability and bonding property.

The chain polymerization polymer (each constitutional component and raw material compound) may have a substituent. The substituent is not particularly limited, and preferred examples thereof include a group selected from the above-described substituent Z. However, a group other than the functional group included in the above-described group (a) of functional groups is preferable.

The content of the constitutional component in the (meth)acrylic polymer is not particularly limited, and it is, for example, appropriately selected and set in the following range. The contents of the constitutional component represented by Formula (1-1) and the constitutional component having a functional group selected from the Group (a) of functional groups are as described above.

The content of the constitutional component derived from the (meth)acrylic compound (M1) in the (meth)acrylic polymer is not particularly limited and may be set to 100% by mole; however, it is preferably 1% to 90% by mole, more preferably 10% to 80% by mole, and particularly preferably 20% to 70% by mole.

The content of the constitutional component derived from the vinyl compound (M2) in the (meth)acrylic polymer is not particularly limited; however, it is preferably 1% to 50% by mole, more preferably 10% to 50% by mole, and particularly preferably 20% to 50% by mole.

The chain polymerization polymer (each constitutional component and raw material compound) may have a substituent. The substituent is not particularly limited as long as it is a group other than the functional group included in the above-described group (a) of functional groups, and preferred examples thereof include a group selected from the substituent Z described above.

The chain polymerization polymer can be synthesized by selecting a raw material compound and polymerizing the raw material compound according to a known method.

The method of incorporating a functional group is not particularly limited, and examples thereof include a method of copolymerizing a compound having a functional group selected from the group (a) of functional groups, a method of using a polymerization initiator having (generating) the above functional group or a chain transfer agent, a method of using a polymeric reaction, an ene reaction or ene-thiol reaction with a double bond (which is formed by a dehydrofluorination reaction of a VDF constitutional component, for example, in a case of a fluoropolymer), and an atom transfer radical polymerization (ATRP) method using a copper catalyst. In addition, a functional group can be introduced by using a functional group that is present in the main chain, the side chain, or the terminal of the polymer, as a reaction point. For example, a functional group selected from the group (a) of functional groups can be introduced by various reactions with a carboxylic acid anhydride group in a polymerized chain using a compound having a functional group.

Specific examples of the polymers that form the polymer binder A or B include those shown below in addition to those synthesized in Examples; however, the present invention is not limited thereto. In each specific example, the number attached at the bottom right of the constitutional component indicates the content in the polymer, where the unit thereof is % by mole.

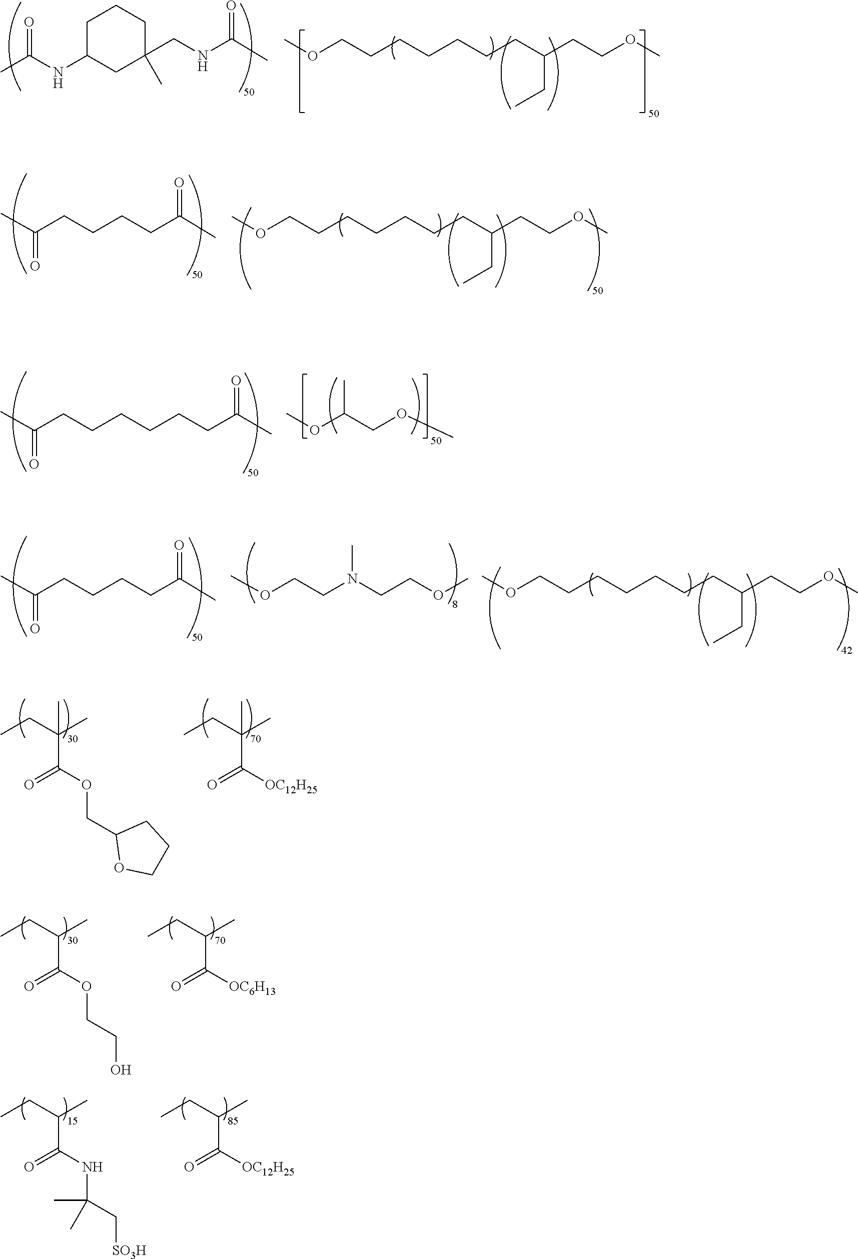

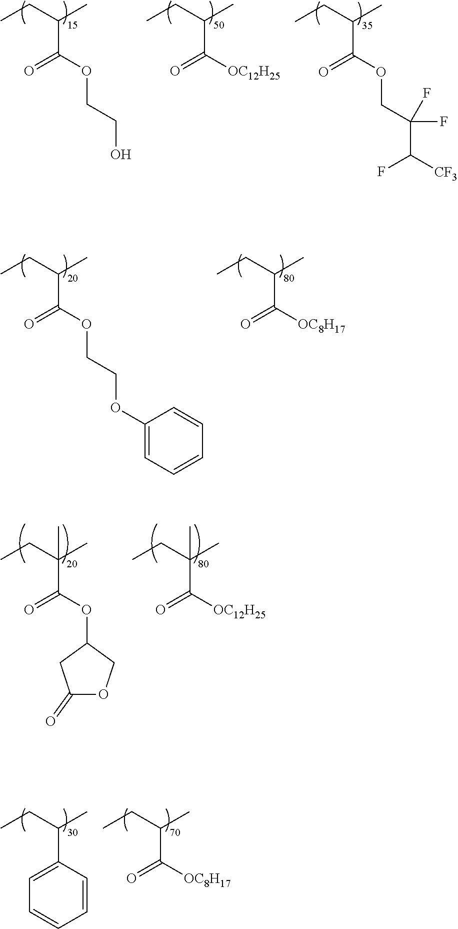

As the polymer binders A and B, an appropriate polymer can be selected as long as the solubility and the adsorption rate are satisfied. For example, the polymer that forms the polymer binder A is preferably a polymer that has, in the main chain, at least one bond of a urethane bond, a urea bond, an amide bond, an imide bond, or an ester bond, and it is more preferably a polymer having a urethane bond in the main chain. The polymer that forms the polymer binder B is preferably a polymer having a polymerized chain of carbon-carbon double bonds in the main chain and more preferably a (meth)acrylic polymer. In addition, the combination of the polymer that forms the polymer binder A and the polymer that forms the polymer binder B is appropriately determined, and the same kind of polymers can be used. However, it is preferable to use polymers of kinds different from each other (for example, polymers in which chemical structures of main chains are different from each other), where specific examples thereof preferably include a combination of preferred ones of each polymer.

(Physical Properties, Characteristics, or the Like of Polymer Binders A and B or Polymers that Form these Polymer Binders)

the polymer binder A or B, or a polymer that forms the polymer binder A or B preferably has the following physical properties, characteristics, or the like.

The mass average molecular weight of the polymer that forms the polymer binder A is not particularly limited; however, it is, for example, preferably 15,000 or more, more preferably 30,000 or more, still more preferably 50,000 or more. The upper limit thereof is practically 5,000,000 or less; however, it is preferably 4,000,000 or less and more preferably 3,000,000 or less, and it can be set to 200,000 or less. On the other hand, the mass average molecular weight of the polymer that forms the polymer binder B is not particularly limited; however, it is, for example, preferably 15,000 or more, more preferably 30,000 or more, still more preferably 50,000 or more. The upper limit thereof is practically 5,000,000 or less; however, it is preferably 4,000,000 or less and more preferably 3,000,000 or less, and it can be set to 200,000 or less.

The mass average molecular weight of the polymer can be appropriately adjusted by changing the kind, content, polymerization time, polymerization temperature, and the like of the polymerization initiator.

### —Measurement of Molecular Weight—

In the present invention, unless specified otherwise, molecular weights of the polymer, the polymer chain, the polymerized chain, and a macromonomer refer to a mass average molecular weight and number average molecular weight in terms of standard polystyrene conversion, which are determined by gel permeation chromatography (GPC). The measuring method thereof includes, basically, a method in which conditions are set to Conditions 1 or Conditions 2 (preferential) described below. However, depending on the kind of polymer, polymer chain, or macromonomer, an appropriate eluent may be suitably selected and used.

### (Condition 1)

Column: Connect two TOSOH TSKgel Super AWM-H (product name, manufactured by Tosoh Corporation)
Carrier: 10 mM LiBr/N-methylpyrrolidone
Measurement temperature: 40° C.
Carrier flow rate: 1.0 ml/min
Sample concentration: 0.1% by mass
Detector: refractive index (RI) detector

### (Condition 2)

Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)
Carrier: tetrahydrofuran
Measurement temperature: 40° C.
Carrier flow rate: 1.0 ml/min
Sample concentration: 0.1% by mass
Detector: refractive index (RI) detector

The adsorption rate of each of the polymer binders A and B with respect to the conductive auxiliary agent described later is not particularly limited. Since the content of the conductive auxiliary agent is small with respect to the active material (AC) and the inorganic solid electrolyte (SE), the influence on the dispersion characteristics and the bonding property is small, and thus the adsorption rate with respect to the conductive auxiliary agent may not be set in a specific range.

The watery moisture concentration of the polymer is preferably 100 ppm (in terms of mass) or lower. In addition, as the polymer binders A and B, those obtained by crystalizing and drying polymers may be used, or a polymer solution may be used as it is.

The polymers that form the polymer binders A and B are preferably noncrystalline. In the present invention, the description that a polymer is “noncrystalline” typically refers to that no endothermic peak due to crystal melting is observed in a case where the measurement is carried out at the glass transition temperature.

The polymers that form polymer binders A and B may be a non-crosslinked polymer or a crosslinked polymer. In addition, in a case where the crosslinking of the polymer progresses due to heating or voltage application, the molecular weight may be higher than the above-described molecular weight. Preferably, the polymer has a mass average molecular weight in the above range at the start of use of the all-solid state secondary battery.

The total content of the polymer binder (PB) in the electrode composition is not particularly limited and is appropriately set, and it can be set to, for example, 0.3% to 3.0% by mass in 100% by mass of the solid content.

The total content of the polymer binders A and B in the electrode composition is appropriately set depending on the content of each of the polymer binders, and it can be set to, for example, 0.5% to 2.0% by mass in 100% by mass of the solid content from the viewpoint that the low resistance, the dispersion characteristics, and the bonding property can be achieved, where it is preferably 0.5% to 1.5% by mass and more preferably 0.5% to 1.0% by mass.

The content of the polymer binder A and the content of the polymer binder B in the electrode composition are not particularly limited and are appropriately set. Both contents can be set, for example, in consideration of the dispersion characteristics and the bonding property of the polymer binder A or B, and in this case, they can be set to 2.0 parts by mass or less with respect to 100 parts by mass of the active material (AC) or the inorganic solid electrolyte (SE) contained in the electrode composition, where they are preferably set to 0.3 to 1.5 parts by mass and more preferably set to 0.5 to 1.0 parts by mass.

The content of the polymer binder A in the electrode composition can be also set to be higher than the content of the polymer binder B in order to adsorb the active material (AC) that is contained generally in a large amount in the electrode composition, and it is preferably 0.1% to 3.0% by mass more, more preferably 0.3% to 3.0% by mass, still more preferably 0.5% to 1.5% by mass, and particularly preferably 0.5% to 1.0% by mass in 100% by mass of the solid content, specifically, from the viewpoint that the low resistance, and the dispersion characteristics (of the polymer binder A, in particular) and the bonding property thereof can be achieved. In addition, the content of the polymer binder B in the electrode composition is, for example, preferably 0.1% to 2.0% by mass, more preferably 0.2% to 1.5% by mass, and still more preferably 0.2% to 1.0% by mass in 100% by mass of the solid content, specifically, from the viewpoint that the low resistance, and the dispersion characteristics (of the polymer binder B, in particular) and the bonding property thereof can be achieved.

Both the difference between the content of the polymer binder A and the content of the polymer binder B (content of polymer binder A—content of polymer binder B) and the ratio of the content of the polymer binder A to the content of the polymer binder B (content of polymer binder A/content of polymer binder B) are not particularly limited and are appropriately set depending on the content or the like of the active material (AC) or the inorganic solid electrolyte (SE).

It is noted that in a case where the electrode composition contains two or more kinds of the polymer binder A or B, the above-described content of the polymer binder A or B shall be in terms of the total content thereof.

### (Other Polymer Binders)

The electrode composition according to the embodiment of the present invention may contain one kind or two or more kinds of polymer binders (referred to as other polymer binders) other than the polymer binders A and B. Focusing on the adsorption rate, examples of the other polymer binders include a low adsorption binder in which the adsorption rates with respect to the active material (AC) and the inorganic solid electrolyte (SE) in the dispersion medium (D) are both less than 20%, and focusing on the solubility in the dispersion medium (D), examples thereof include a particulate binder insoluble in the dispersion medium (D).

As the polymers that form the other polymer binders, various polymers that are used as a binding agent for an all-solid state secondary battery can be used without particular limitation, as long as the adsorption rate or the solubility is satisfied. Examples thereof include the sequential polymerization polymer and the chain polymerization polymer, which are described above. Examples of the particulate binder include the binders disclosed in JP2015-088486A, WO2017/145894A, and WO2018/020827A. The particle diameter of the particulate binder (according to the same measuring method as that of the inorganic solid electrolyte) is not particularly limited and can be set to, for example, 1 to 1,000 nm.

The content of the other polymer binders is not particularly limited and can be appropriately set within a range where the effect of the present invention is not impaired, and it can be set to, for example, 1% by mass or less.

In the present invention, the mass ratio of the total mass of the inorganic solid electrolyte (SE) and the active material (AC) to the total mass of the polymer binder (PB) [(mass of SE+mass of AC)/(total mass of polymer binder (PB))] in 100% by mass of the solid content is preferably in a range of 1,000 to 1. Furthermore, this ratio is more preferably 500 to 2 and still more preferably 100 to 10.

### <Dispersion Medium (D)>

The electrode composition according to the embodiment of the present invention contains the dispersion medium (D) that disperses or dissolves each of the above components.

Such a dispersion medium (D) may be any organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium (D) may be a non-polar dispersion medium (a hydrophobic dispersion medium) or a polar dispersion medium (a hydrophilic dispersion medium); however, a non-polar dispersion medium is preferable from the viewpoint that excellent dispersion characteristics can be exhibited. The non-polar dispersion medium generally means a dispersion medium having a property of a low affinity to water; however, in the present invention, examples thereof include an ester compound, a ketone compound, an ether compound, an aromatic compound, and an aliphatic compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, propylene glycol monomethyl ether, diethylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, xylene, and perfluorotoluene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The boiling point of the dispersion medium at normal pressure (1 atm) is not particularly limited; however, it is preferably 90° C. or higher, and it is more preferably 120° C. or higher. The upper limit thereof is preferably 230° C. or lower and more preferably 200° C. or lower.

The dispersion medium (D) contained in the electrode composition according to the embodiment of the present invention may be one kind or may be two or more kinds.

The content of the dispersion medium (D) in the electrode composition is not particularly limited and can be appropriately set. For example, the content of the dispersion medium in the electrode composition is preferably 20% to 80% by mass, more preferably 30% to 70% by mass, and particularly preferably 40% to 60% by mass.

### <Conductive Auxiliary Agent (CA)>

The electrode composition according to the embodiment of the present invention preferably contains a conductive auxiliary agent (CA).

The conductive auxiliary agent is not particularly limited, and a conductive auxiliary agent that is known as an ordinary conductive auxiliary agent can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

The conductive auxiliary agent contained in the electrode composition according to the embodiment of the present invention preferably has a particle shape in the electrode composition. The shape of the particle is not particularly limited and may be a flat shape, an amorphous shape, or the like; however, a spherical shape or a granular shape is preferable. In a case where the conductive auxiliary agent has a particle shape, the particle diameter (volume average particle diameter) of the conductive auxiliary agent is not particularly limited; however, it is, for example, preferably 0.02 to 1.0 μm and more preferably 0.03 to 0.5 μm. The particle diameter of the conductive auxiliary agent can be adjusted in the same manner as in the adjustment of the particle diameter of the inorganic solid electrolyte, and the particle diameter thereof can be measured by the same measuring method as the method for the particle diameter of the inorganic solid electrolyte.

The conductive auxiliary agent contained in the electrode composition according to the embodiment of the present invention may be one kind or two or more kinds.

The content of the conductive auxiliary agent in the electrode composition is not particularly limited and is appropriately determined. For example, in 100% by mass of the solid content, it is preferably 10% by mass or less and more preferably 1.0% to 5.0% by mass.

### <Lithium Salt>

The electrode composition according to the embodiment of the present invention can also contain a lithium salt (supporting electrolyte). Generally, the lithium salt is preferably a lithium salt that is used for this kind of product and is not particularly limited. For example, lithium salts described in paragraphs 0082 to 0085 of JP2015-088486A are preferable. In a case where the electrode composition according to the embodiment of the present invention contains a lithium salt, the content of the lithium salt is preferably 0.1 parts by mass or more and more preferably 5 parts by mass or more with respect to 100 parts by mass of the inorganic solid electrolyte. The upper limit thereof is preferably 50 parts by mass or less and more preferably 20 parts by mass or less.

### <Dispersing Agent>

Since the above-described polymer binder (PB), particularly the polymer binders A and B also functions as a dispersing agent, the electrode composition according to the embodiment of the present invention may not contain a dispersing agent other than the polymer binder (PB). In a case where the electrode composition contains a dispersing agent other than the polymer binder (PB), a dispersing agent that is generally used for an all-solid state secondary battery can be appropriately selected and used as the dispersing agent. Generally, a compound intended for particle adsorption and steric repulsion and/or electrostatic repulsion is suitably used.

### <Other Additives>

As a component other than each of the components described above, the electrode composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an anti-foaming agent, a leveling agent, a dehydrating agent, or an antioxidant. The ionic liquid is contained in order to further improve the ion conductivity, and the known one in the related art can be used without particular limitation.

### (Preparation of Electrode Composition)

The electrode composition according to the embodiment of the present invention can be prepared according to a conventional method. For example, it can be prepared as a mixture and preferably as a slurry by mixing the inorganic solid electrolyte (SE), the active material (AC), the polymer binder (PB), and the dispersion medium (D), and further, appropriately the conductive auxiliary agent (CA), a lithium salt, and any other components, by using, for example, various mixers that are usually used.

The mixing method of the above-described components is not particularly limited, and the above-described components may be mixed collectively or may be mixed sequentially. The collective mixing method can be preferably applied in terms of work efficiency in a case where the difference in the adsorption rates A_{AC} and A_{SE} of the polymer binders A and B is large. In the present invention, it is preferable to prepare an electrode composition by mixing the above-described components according to the preparation method for the electrode composition according to the embodiment of the present invention, which has the following steps. According to this method, it is possible to preferentially adsorb the polymer binder A to the active material (AC), it is possible to preferentially adsorb the polymer binder B to the inorganic solid electrolyte (SE), and as a result, it is possible to further enhance the dispersion characteristics and the bonding property of each of the active material (AC)) and the inorganic solid electrolyte (SE).

### Preparation Step for Active Material Composition:

A step of preparing an active material composition containing the active material (AC), the polymer binder A, and the dispersion medium (D)

### Preparation Step for Solid Electrolyte Composition:

A step of preparing a solid electrolyte composition containing the inorganic solid electrolyte (SE), the polymer binder B, and the dispersion medium (D)

### Preparation Step for Electrode Composition:

A step of mixing the prepared active material composition with the prepared solid electrolyte composition.

### —Preparation Step for Active Material Composition—

In the preparation step for an active material composition, the active material (AC), the polymer binder A, and the dispersion medium (D) are (preliminarily) mixed to prepare an active material composition. This step enables the polymer binder A to be preferentially adsorbed to the active material (AC) (while avoiding the adsorption to the inorganic solid electrolyte (SE)), whereby a mixture (slurry) in which the active material (AC) has been adsorbed (bound) to the polymer binder A is obtained. In this step, it is preferable that the mixing is carried out in the absence of the inorganic solid electrolyte (SE) and/or the polymer binder B in order to increase the preferential adsorption of the polymer binder A to the active material (AC). Here, the phrase “in the absence” includes a range where the effect of the present invention is not impaired, for example, an aspect in which the inorganic solid electrolyte (SE) and the polymer binder B are each present such that the content thereof is 5% by mass or less with respect to the solid content of the electrode composition.

In this step, the using amount of each component is appropriately set in consideration of the content of each component in the target electrode composition. In general, the mixing amount (the content) of each of the active material (AC) and the polymer binder A is set in the same range as the content of each component in 100% by mass of the solid content in the electrode composition. That is, although the mixing ratio of the active material (AC) to the polymer binder A is not particularly limited, in general, it is preferably to set to the mixing ratio of the active material (AC) to the polymer binder A in the electrode composition in terms of work efficiency.

The using amount of the dispersion medium (D) is appropriately set in consideration of the content of the dispersion medium (D) in the electrode composition, the using amount of the dispersion medium (D) in the preparation step for a solid electrolyte composition, and the like; however, it is preferably set to a using amount at which the polymer binder A is dissolved. For example, it can be set to 20% to 85% by mass, and it is preferably set to 40% to 80% by mass in a case of focusing on the concentration of solid contents of the active material composition to be obtained. On the other hand, it can be set to 0.1% to 70% by mass, and it is preferably set to 0.5% to 60% by mass among the following 100% by mass of content in a case of focusing on the content of the dispersion medium (D) in the electrode composition and in a case of setting the content thereof to 100% by mass.

The mixing method and mixing conditions in this step are not particularly limited and can be appropriately set.

For example, regarding the mixing order, each of the components may be mixed collectively or may be mixed sequentially. In addition, the mixing method can be carried out by using, for example, a known mixer such as a ball mill, a beads mill, a planetary mixer, a blade mixer, a roll mill, a kneader, a disc mill, a self-rotation type mixer, or a narrow gap type disperser. The mixing conditions are set to, for example, a mixing temperature of 10° C. to 60° C. and a rotation speed of a self-rotation type mixer or the like to 10 to 700 rpm (rotation per minute (rpm), and the mixing time can be set to 5 minutes to 5 hours. In a case where a ball mill is used as the mixer, it is preferable to set the rotation speed at 50 to 700 rpm and the mixing time at 5 minutes to 24 hours and preferably 5 minutes to 60 minutes at the mixing temperature described above.

The mixing atmosphere may be any atmosphere such as atmospheric air, dry air (the dew point: −20° C. or lower), or inert gas (for example, an argon gas, a helium gas, or a nitrogen gas). Since the inorganic solid electrolyte easily reacts with watery moisture, the mixing is preferably carried out under dry air or in an inert gas.

It is noted that the mixing in this step can also be dividedly carried out a plurality of times.

### —Preparation Step for Solid Electrolyte Composition—

In the preparation step for a solid electrolyte composition, the inorganic solid electrolyte (SE), the polymer binder B, and the dispersion medium (D) are (preliminarily) mixed to prepare an inorganic solid electrolyte composition. This step enables the polymer binder B to be preferentially adsorbed to the inorganic solid electrolyte (SE) (while avoiding the adsorption to the active material (AC)), whereby a mixture (slurry) in which the inorganic solid electrolyte (SE) has been adsorbed (bound) to the polymer binder B is obtained. In this step, it is preferable that the mixing is carried out in the absence of the active material (AC) and/or the polymer binder A in order to increase the preferential adsorption of the polymer binder B to the inorganic solid electrolyte (SE). Here, the phrase “in the absence” includes a range where the effect of the present invention is not impaired, for example, an aspect in which the active material (AC) and the polymer binder A are each present such that the content thereof is 10% by mass or less with respect to the solid content of the electrode composition.

In this step, the using amount of each component is appropriately set in consideration of the content of each component in the target electrode composition. In general, the mixing amount (the content) of each of the inorganic solid electrolyte (SE) and the polymer binder B is set in the same range as the content of each component in 100% by mass of the solid content in the electrode composition. That is, although the mixing ratio of the inorganic solid electrolyte (SE) to the polymer binder B is not particularly limited, in general, it is preferably set to the mixing ratio of the inorganic solid electrolyte (SE) to the polymer binder B in the electrode composition in terms of work efficiency.

The using amount of the dispersion medium (D) is appropriately set in consideration of the content of the dispersion medium (D) in the electrode composition, the using amount of the dispersion medium (D) in the preparation step for an active material composition, and the like; however, it is preferably set to a using amount at which the polymer binder B is dissolved. For example, it can be set to 20% to 85% by mass, and it is preferably set to 40% to 80% by mass in a case of focusing on the concentration of solid contents of the solid electrolyte composition to be obtained. On the other hand, it can be set to 0.1% to 70% by mass, and it is preferably set to 0.5% to 60% by mass among the following 100% by mass of content in a case of focusing on the content of the dispersion medium (D) in the electrode composition and in a case of setting the content thereof to 100% by mass. Regarding the using amount of the dispersion medium (D), it is preferable that the total using amount in the preparation step for an active material composition and the preparation step for a solid electrolyte composition is set in the same range as the content of the dispersion medium (D) in the electrode composition.

The mixing method and mixing conditions in this step are not particularly limited and can be appropriately set. For example, the mixing method and the mixing conditions in the preparation step for an active material composition can be applied. It is noted that the mixing method and mixing conditions, which are adopted in this step, may be the same or different from the mixing method and mixing conditions in the preparation step for an active material composition.

### —Preparation Step for Electrode Composition—

In the preparation method for the electrode composition according to the embodiment of the present invention, a step of mixing the active material composition and the solid electrolyte composition, which are obtained in the respective steps described above, to prepare an electrode composition is carried out. This makes it possible to highly disperse each component in the dispersion medium (D) while maintaining the adsorption state between the active material (AC) and the polymer binder A in the active material composition and the adsorption state between the inorganic solid electrolyte (SE) and the polymer binder B in the solid electrolyte composition.

In this step, the mixing ratio of the active material composition to the solid electrolyte composition is not particularly limited. However, It is preferable that the mixing is carried out at such a proportion that the content of each of the active material (AC), the inorganic solid electrolyte (SE), the polymer binder A, and the polymer binder B is the same as the content of each component in the electrode composition. It is noted that regarding the dispersion medium (D), a shortage content with respect to the content in the electrode composition can be additionally mixed in this step, or the excess content can be concentrated.

The mixing method and mixing conditions in this step are not particularly limited and can be appropriately set. For example, the mixing method and the mixing conditions in the preparation step for an active material composition can be applied. It is noted that the mixing method and mixing conditions, which are adopted in this step, may be the same or different from the mixing method and mixing conditions in the preparation step for an active material composition or the preparation step for a solid electrolyte composition.

In the active material composition obtained in the preparation step for an active material composition and the solid electrolyte composition obtained in the preparation step for a solid electrolyte composition in the preparation method for the electrode composition according to the embodiment of the present invention, the active material (AC) or the inorganic solid electrolyte (SE) is adsorbed to the polymer binder A or the polymer binder B to be dispersed in the dispersion medium (D), and thus the preparation step for an electrode composition does not need to be carried out immediately after the completion of both the preparation steps for a composition, and it can be carried out with a time interval within a range where the dispersibility of both compositions is not impaired.

In a case where the conductive auxiliary agent (CA), a lithium salt, a dispersing agent, and other additives are used in the preparation method for the electrode composition according to the embodiment of the present invention, these components may be mixed in any step. These components are preferably mixed in the preparation step for an electrode composition from the viewpoint that the preferential adsorption of the active material (AC) or the inorganic solid electrolyte (SE) to the polymer binder A or the polymer binder B is not inhibited. The mixing amount of these components is, in general, preferably set in the same range as the content in the electrode composition.

[Electrode Sheet for all-Solid State Secondary Battery]

The electrode sheet for an all-solid state secondary battery according to the embodiment of the present invention (simply, may be also referred to as an electrode sheet) is a sheet-shaped molded body with which an active material layer or electrode (a laminate of an active material layer and a collector) of an all-solid state secondary battery can be formed, and it includes various aspects depending on use applications thereof.

The electrode sheet according to the embodiment of the present invention may be any electrode sheet having an active material layer composed of the above-described electrode composition according to the embodiment of the present invention, and it may be a sheet in which the active material layer is formed on a base material (collector) or may be a sheet which does not have a base material and is formed from an active material layer. The electrode sheet is typically a sheet including the base material (collector) and the active material layer, and examples of an aspect thereof include an aspect including the base material (collector), the active material layer, and the solid electrolyte layer in this order and an aspect including the base material (collector), the active material layer, the solid electrolyte layer, and the active material layer in this order.

In addition, the electrode sheet may have another layer in addition to each of the above-described layers. Examples of the other layer include a protective layer (a peeling sheet) and a coating layer.

The base material is not particularly limited as long as it can support the active material layer, and examples thereof include a sheet body (plate-shaped body) formed of a material described later regarding the collector, an organic material, and an inorganic material. Examples of the organic materials include various polymers, and specific examples thereof include polyethylene terephthalate, polypropylene, polyethylene, and cellulose. Examples of the inorganic materials include glass and ceramic.

At least one of the active material layers included in the electrode sheet is formed of the electrode composition according to the embodiment of the present invention. The content of each component in the active material layer formed of the electrode composition according to the embodiment of the present invention is not particularly limited; however, it preferably has the same meaning as the content of each component in the solid content of the electrode composition according to the embodiment of the present invention. The layer thickness of each of the layers that constitute the electrode sheet according to the embodiment of the present invention is the same as the layer thickness of each of the layers described later regarding the all-solid state secondary battery.

In the present invention, each layer that constitutes a sheet for an all-solid state secondary battery may have a monolayer structure or a multilayer structure.

It is noted that in a case where the solid electrolyte layer or the active material layer is not formed of the electrode composition according to the embodiment of the present invention, it is formed of a general constitutional layer forming material.

The electrode sheet according to the embodiment of the present invention has an active material layer that is formed of the electrode composition according to the embodiment of the present invention, and it has a low-resistance active material layer, on which solid particles are firmly bound to each other. As a result, in a case of using the electrode sheet for an all-solid state secondary battery according to the embodiment of the present invention as an active material layer of an all-solid state secondary battery, it is possible to realize an all-solid state secondary battery that has low resistance and exhibits excellent rate characteristics. In particular, in the electrode sheet for an all-solid state secondary battery, in which the active material layer is formed on the collector, the active material layer and the collector exhibit firm adhesiveness, which makes it possible to realize the further improvement of the rate characteristics. As described above, the electrode sheet for an all-solid state secondary battery according to the embodiment of the present invention is suitably used as an active material layer of an all-solid state secondary battery and preferably as a sheet-shape member that forms an electrode (that is incorporated as an active material layer or an electrode).

[Manufacturing Method for Electrode Sheet for all-Solid State Secondary Battery]

A manufacturing method for an electrode sheet for an all-solid state secondary battery according to the embodiment of the present invention is not particularly limited and can be manufactured by forming the active material layer by using the electrode composition according to the embodiment of the present invention and preferably the electrode composition prepared by the preparation method for the electrode composition according to the embodiment of the present invention. Examples thereof include a method of forming a film (carrying out coating and drying) of the electrode composition according to the embodiment of the present invention on the surface of a base material (another layer may be interposed) to form a layer (a coated and dried layer) consisting of the electrode composition. This makes it possible to produce an electrode sheet for an all-solid state secondary battery including a base material and a coated and dried layer. In particular, in a case of employing a collector as the base material, the adhesion between the collector and the active material layer (the coated and dried layer) can be strengthened. Here, the coated and dried layer refers to a layer formed by carrying out coating with the electrode composition according to the embodiment of the present invention and drying the dispersion medium (that is, a layer formed using the electrode composition according to the embodiment of the present invention and consisting of a composition obtained by removing the dispersion medium from the electrode composition according to the embodiment of the present invention). In the active material layer and the coated and dried layer, the dispersion medium may remain within a range where the effect of the present invention is not impaired, and the residual amount thereof, for example, in a coated and dried layer may be 3% by mass or lower.

In the manufacturing method for an electrode sheet for an all-solid state secondary battery according to the embodiment of the present invention, each of the steps such as coating and drying will be described in the following manufacturing method for an all-solid state secondary battery.

In this way, it is possible to produce an electrode sheet for an all-solid state secondary battery having an active material layer that has been produced by appropriately subjecting an active material layer consisting of a coated and dried layer or a coated and dried layer to a pressurization treatment or the like. The pressurizing condition and the like will be described later in the section of the manufacturing method for an all-solid state secondary battery.

In addition, in the manufacturing method for an electrode sheet for an all-solid state secondary battery according to the embodiment of the present invention, the base material, the protective layer (particularly a peeling sheet), or the like can also be peeled.

### [All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. In a preferred all-solid state secondary battery, a positive electrode collector is laminated on a surface of the positive electrode active material layer opposite to the solid electrolyte layer to constitute a positive electrode, and a negative electrode collector is laminated on a surface of the negative electrode active material layer opposite to the solid electrolyte layer to constitute a negative electrode. In the present invention, each constitutional layer (including a collector and the like) that constitutes an all-solid state secondary battery may have a monolayer structure or a multilayer structure.

In the all-solid state secondary battery according to the embodiment of the present invention, it is preferable that at least one layer of the negative electrode active material layer or the positive electrode active material layer is formed of the electrode composition according to the embodiment of the present invention and at least the positive electrode active material layer is formed of the electrode composition according to the embodiment of the present invention. In addition, an aspect in which both the negative electrode active material layer and the positive electrode active material layer are formed of the electrode composition according to the embodiment of the present invention is also one of the preferred aspects. In addition, it is preferable that any one of the negative electrode (a laminate of a negative electrode collector and a negative electrode collector) and the positive electrode (a laminate of a positive electrode collector and a positive electrode collector), preferably the positive electrode is formed of the electrode sheet for an all-solid state secondary battery according to the embodiment of the present invention, and an aspect in which both of them are formed of the electrode sheet for an all-solid state secondary battery according to the embodiment of the present invention is also one of the preferred aspects. In the present invention, forming the active material layer of the all-solid state secondary battery by using the electrode composition according to the embodiment of the present invention includes an aspect in which a constitutional layer is formed by using the electrode sheet for an all-solid state secondary battery according to the embodiment of the present invention (however, in a case where a layer other than the active material layer formed of the electrode composition according to the embodiment of the present invention is provided, a sheet from which this layer has been removed).

In the active material layer formed of the electrode composition according to the embodiment of the present invention, it is preferable that the kinds of components to be included and the content thereof are the same as those of the solid content of the electrode composition according to the embodiment of the present invention.

It is noted that in a case where the active material layer is not formed of the electrode composition according to the embodiment of the present invention, the active material layer and the solid electrolyte layer can be produced using known materials.

In the present invention, each constitutional layer (including a collector and the like) that constitutes an all-solid state secondary battery may have a monolayer structure or a multilayer structure.

### <Positive Electrode Active Material Layer and Negative Electrode Active Material Layer>

The thickness of each of the negative electrode active material layer and the positive electrode active material layer is not particularly limited. In case of taking a dimension of a general all-solid state secondary battery into account, the thickness of each of the layers is preferably 10 to 1,000 μm and more preferably 20 μm or more and less than 500 m. In the all-solid state secondary battery according to the embodiment of the present invention, the thickness of at least one layer of the positive electrode active material layer or the negative electrode active material layer is still more preferably 50 μm or more and less than 500 μm.

### <Solid Electrolyte Layer>

The solid electrolyte layer is formed of a known material that is capable of forming a solid electrolyte layer of an all-solid state secondary battery. The thickness thereof is not particularly limited; however, it is preferably 10 to 1,000 μm, and more preferably 20 μm or more and less than 500 μm.

### <Collector>

It is preferable that each of the positive electrode active material layer and the negative electrode active material layer includes a collector on the side opposite to the solid electrolyte layer. Such a positive electrode collector and such a negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

The material that forms the negative electrode collector is preferably, in addition to aluminum, copper, a copper alloy, stainless steel, nickel, titanium, and the like, a material obtained by treating the surface of aluminum, copper, a copper alloy, or stainless steel with carbon, nickel, titanium, or silver, and it is more preferably aluminum, copper, a copper alloy, or stainless steel.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

### <Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

### <Housing>

Depending on the use application, the all-solid state secondary battery according to the embodiment of the present invention may be used as the all-solid state secondary battery having the above-described structure as it is; however, it is preferably further sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is divided into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

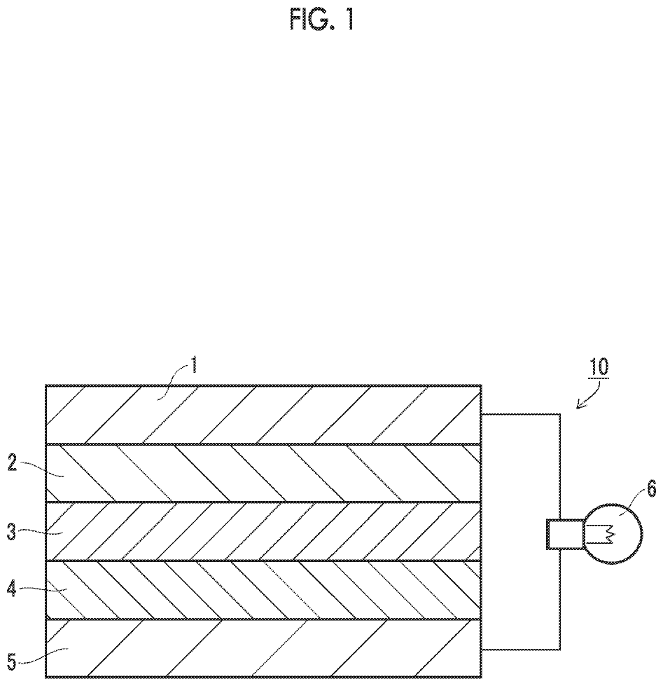

Hereinafter, the all-solid state secondary battery according to the preferred embodiment of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is placed in a 2032-type coin case, the all-solid state secondary battery will be referred to as a laminate for an all-solid state secondary battery, and a battery produced by placing this laminate for an all-solid state secondary battery in a 2032-type coin case will be referred to as a (coin-type) all-solid state secondary battery, whereby both batteries may be distinctively referred to in some cases.

### (Solid Electrolyte Layer)

As the solid electrolyte layer, a solid electrolyte layer in the related art, which is applied to an all-solid state secondary battery, can be used without particular limitation. This solid electrolyte layer appropriately contains an inorganic solid electrolyte having an ion conductivity of a metal belonging to Group 1 or Group 2 in the periodic table, any component described above, and the like, and it generally does not contain an active material.

### (Positive Electrode Active Material Layer and Negative Electrode Active Material Layer)

In the all-solid state secondary battery 10, both the positive electrode active material layer and the negative electrode active material layer are formed of the electrode composition according to the embodiment of the present invention. Preferably, the positive electrode in which the positive electrode active material layer and the positive electrode collector are laminated, and the negative electrode in which the negative electrode active material layer and the negative electrode collector are laminated are formed of the electrode sheet according to the embodiment of the present invention, to which a collector is applied as a base material.

The positive electrode active material layer contains an inorganic solid electrolyte having an ion conductivity of a metal belonging to Group 1 or Group 2 in the periodic table, a positive electrode active material, polymer binders A and B, and any component described above or the like within a range where the effect of the present invention is not impaired.

The negative electrode active material layer contains an inorganic solid electrolyte having an ion conductivity of a metal belonging to Group 1 or Group 2 in the periodic table, a negative electrode active material, polymer binders A and B, and any component described above or the like within a range where the effect of the present invention is not impaired. In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above-described thickness of the above negative electrode active material layer.

The kinds of the respective components contained in the positive electrode active material layer 4, the solid electrolyte layer 3, and the negative electrode active material layer 2, particularly the kinds of the inorganic solid electrolyte, the conductive auxiliary agent, and the polymer binder may be the same or different from each other.

In the present invention, in a case of forming the active material layer with the electrode composition according to the embodiment of the present invention, it is possible to realize an all-solid state secondary battery having low resistance and excellent rate characteristics.

### (Collector)

The positive electrode collector 5 and the negative electrode collector 1 are as described above.

In a case where the all-solid state secondary battery 10 has a constitutional layer other than the constitutional layer formed of the electrode composition according to the embodiment of the present invention, a layer formed of a known constitutional layer forming material can also be applied.

In addition, each layer may be composed of a single layer or multiple layers.

[Manufacturing of all-Solid State Secondary Battery]

The all-solid state secondary battery can be manufactured according to a conventional method. Specifically, the all-solid state secondary battery can be manufactured by forming at least one active material layer by using the electrode composition according to the embodiment of the present invention or the like, and then forming a solid electrolyte layer and appropriately the other active material layer or an electrode by using the known materials.

The all-solid state secondary battery according to the embodiment of the present invention can be manufactured by carrying out a method (a manufacturing method for an electrode sheet for an all-solid state secondary battery according to the embodiment of the present invention) which includes (is carried out through) a step of appropriately coating and drying on a surface of a base material (for example, a metal foil serving as a collector) with the electrode composition according to the embodiment of the present invention to form a coating film (form a film).

For example, an electrode composition which contains a positive electrode active material and serves as a positive electrode material (a positive electrode composition) is applied onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Further, the electrode composition containing a negative electrode active material as a negative electrode material (a negative electrode composition) is applied onto the solid electrolyte layer to form a negative electrode active material layer. A negative electrode collector (a metal foil) is superposed on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by sealing the all-solid state secondary battery in a housing.

In addition, it is also possible to manufacture an all-solid state secondary battery by carrying out the forming method of each layer in reverse order to form a negative electrode active material layer, a solid electrolyte layer, and a positive electrode active material layer on a negative electrode collector and superposing a positive electrode collector thereon.

As another method, the following method can be exemplified. That is, the positive electrode sheet for an all-solid state secondary battery is produced as described above. In addition, an electrode composition which contains a negative electrode active material and serves as a negative electrode material (a negative electrode composition) is applied onto a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Further, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, the positive electrode sheet for an all-solid state secondary battery and the negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Further, the positive electrode sheet for an all-solid state secondary battery and the negative electrode sheet for an all-solid state secondary battery are laminated such that the solid electrolyte layer removed from the base material is sandwiched therebetween. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are superposed and pressurized into a state where the positive electrode active material layer or the negative electrode active material layer is brought into contact with the solid electrolyte layer. In this way, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are superposed and pressurized (into a state where the negative electrode active material layer or positive electrode active material layer is brought into contact with the solid electrolyte layer). In this way, an all-solid state secondary battery can be manufactured. The pressurizing method and the pressurizing conditions in this method are not particularly limited, and a method and pressurizing conditions described in the pressurization step, which will be described later, can be applied.

The active material layer or the like can also be formed on the substrate or the active material layer, for example, by subjecting the electrode composition or the like to pressure molding under a pressurizing condition described below, or a sheet molded body of the active material can also be used.

In the above-described manufacturing method, it suffices that the electrode composition according to the embodiment of the present invention is used for any one of the positive electrode composition or the negative electrode composition, and the electrode composition according to the embodiment of the present invention can also be used for both the positive electrode composition and the negative electrode composition.

In a case where the active material layer is formed of a composition other than the electrode composition according to the embodiment of the present invention, examples of the material thereof include a typically used composition. In addition, the negative electrode active material layer can also be formed by binding ions of a metal belonging to Group 1 or Group 2 in the periodic table, which are accumulated on a negative electrode collector by initialization described later or charging during use, without forming the negative electrode active material layer during the manufacturing of the all-solid state secondary battery to electrons and precipitating the ions on a negative electrode collector the like as a metal.

### <Formation (Film Formation) of Each Layer>

The coating method for each composition is not particularly limited and can be appropriately selected. Examples thereof include wet-type coating methods such as coating (preferably wet-type coating), spray coating, spin coating, dip coating, slit coating, stripe coating, and bar coating.

The applied composition is preferably subjected to a drying treatment (a heating treatment). The drying treatment may be carried out each time after the composition is applied or may be carried out after it is subjected to multilayer application. The drying temperature is not particularly limited as long as the dispersion medium can be removed, and it is appropriately set according to the boiling point of the dispersion medium. The lower limit of the drying temperature is, for example, preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain a favorable application suitability (adhesiveness) and a favorable ion conductivity even without pressurization.

In a case where the electrode composition according to the embodiment of the present invention is subjected to coating and drying as described above, it is possible to suppress the variation in the contact state and firmly bind solid particles, and furthermore, it is possible to form a coated and dried layer having low resistance.

After applying each composition, it is preferable to pressurize each layer or the all-solid state secondary battery after superimposing the constitutional layers or producing the all-solid state secondary battery. Examples of the pressurizing methods include a method using a hydraulic cylinder press machine. The pressurizing force is not particularly limited; however, it is, in general, preferably in a range of 5 to 1,500 MPa.

In addition, each of the applied compositions may be heated while being pressurized. The heating temperature is not particularly limited; however, it is generally in a range of 30° C. to 300° C. The pressing can also be applied at a temperature higher than the glass transition temperature of the inorganic solid electrolyte. It is also possible to carry out pressing at a temperature higher than the glass transition temperature of the polymer that constitutes a polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be subjected to coating at the same time, or the coating, the drying, and the pressing may be carried out simultaneously and/or sequentially. Each of the compositions may be applied onto each of the separate base materials and then laminated by carrying out the transfer.

The atmosphere in the film forming method (coating, drying, and pressurization (under heating) is not particularly limited and may be any atmosphere such as atmospheric air, dry air (the dew point: −20° C. or lower), or inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the electrode sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure may be variable depending on the area or the film thickness of the portion under pressure. In addition, the pressure may also be variable stepwise for the same portion.

A pressing surface may be flat or roughened.

### <Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Use Application of all-Solid State Secondary Battery]

The all-solid state secondary battery according to the embodiment of the present invention can be applied to a variety of use applications. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Further, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

### 1. Polymer Synthesis

Polymers S1 to S15 shown in the following chemical formulae were synthesized as follows.

### Synthesis Example S1: Synthesis of Polymer S1 and Preparation of Binder Solution S1

To a 200 mL three-neck flask, 46.1 g of NISSO-PB GI-3000 (product name, manufactured by NIPPON SODA Co., Ltd.) was added and dissolved in 64 g of butyl butyrate (manufactured by Tokyo Chemical Industry Co., Ltd.). To this solution, 3.9 g of dicyclohexylmethane-4,4′-diisocyanate (manufactured by Tokyo Chemical Industry Co., Ltd.) was added and stirred at 80° C. to be homogeneously dissolved. To the obtained solution, 0.1 g of Neostan U-600 (product name, manufactured by Nitto Kasei Co., Ltd.) was added and stirred at 80° C. for 10 hours to synthesize a polymer S1 (polyurethane), and a polymer binder solution S1 (concentration: 40% by mass) consisting of the polymer S1 was obtained.

### Synthesis Example S2: Synthesis of Polymer S2 and Preparation of Binder Solution S2

A polymer S2 (polyurethane) was synthesized in the same manner as in Synthesis Example S1, and a polymer binder solution S2 consisting of the polymer S2 was obtained except that in Synthesis Example S1, a compound from which each constitutional component was derived was used so that the polymer S2 had the composition (the kind and the content of the constitutional component) shown in Table 1.

### Synthesis Example S3: Synthesis of Polymer S3 and Preparation of Binder Solution S3

To a 100 mL volumetric flask, 2.9 g of 2-hydroxyethyl acrylate (manufactured by FUJIFILM Wako Pure Chemical Corporation), 19.1 g of dodecyl methacrylate (manufactured by Tokyo Chemical Industry Co., Ltd.), and 0.3 g of a polymerization initiator V-601 (product name, manufactured by FUJIFILM Wako Pure Chemical Corporation) were added and dissolved in 36 g of butyl butyrate to prepare a monomer solution. Next, 12 g of butyl butyrate was added to a 300 mL three-neck flask and stirred at 80° C., and the above-described monomer solution was added dropwise thereto over 2 hours. After completion of the dropwise addition, the temperature was raised to 90° C., and stirring was carried out for 2 hours to synthesize a polymer S3 (an acrylic polymer), whereby a polymer binder solution S3 (concentration: 30% by mass) consisting of the polymer S3 was obtained.

### Synthesis Example S4: Synthesis of Polymer S4 and Preparation of Binder Solution S4

A polymer S4 (acrylic polymer) was synthesized in the same manner as in Synthesis Example S3, and a polymer binder solution S4 consisting of the polymer S4 was obtained except that in Synthesis Example S3, a compound from which each constitutional component was derived was used so that the polymer S4 had the composition (the kind and the content of the constitutional component) shown in Table 1.

### Synthesis Examples S5 and S6: Synthesis of Polymers S5 and S6 and Preparation of Binder Solutions S5 and S6

Each of polymers S5 and S6 (acrylic polymers) was synthesized in the same manner as in Synthesis Example S3 to obtain each of polymer binder solutions S5 and S6 consisting of the respective polymers, except that in Synthesis Example S3, a compound from which each constitutional component was derived was used so that each of the polymers S5 and S6 had the composition (the kind and the content of the constitutional component) shown in Table 1.

### Synthesis Example S7: Synthesis of Polymer S7 and Preparation of Binder Dispersion Liquid S7

200 g of heptane was poured to a 1 L three-neck flask equipped with a reflux condenser and a gas introduction coke, nitrogen gas was introduced at a flow rate of 200 mL/min for 10 minutes, and the solution was heated to 80° C. A liquid (a liquid in which 177 g of ethyl acrylate (manufactured by Fujifilm Wako Pure Chemical Corporation), 13 g of acrylic acid (manufactured by Fujifilm Wako Pure Chemical Corporation), 100 g (solid content) of a macromonomer AB-6 (product name, manufactured by TOAGOSEI Co., Ltd.), and 2.0 g of a polymerization initiator V-601 (manufactured by Fujifilm Wako Pure Chemical Corporation) were mixed with each other) prepared in a separate container was added dropwise to the solution for 2 hours and was stirred at 80° C. for 2 hours. Next, 1.0 g of V-601 was further added to the obtained mixture, and the solution was stirred at 90° C. for 2 hours. The obtained solution was diluted with heptane to obtain a dispersion liquid S7 of a particulate binder (concentration: 10% by mass, particle diameter: 150 nm) consisting of the polymer S7.

### Synthesis Examples S8 to S14: Synthesis of Polymers S8 to S14 and Preparation of Binder Solutions S8 to S14

Each of polymers S8 to S13 (acrylic polymers) and a polymer S14 (a vinyl polymer) was synthesized in the same manner as in Synthesis Example S3 to obtain each of polymer binder solutions S8 to S14 consisting of the respective polymers, except that in Synthesis Example S3, a compound from which each constitutional component was derived was used so that each of the polymers S8 to S14 had the composition (the kind and the content of the constitutional component) shown in Table 1.

### Synthesis Example S15: Synthesis of Polymer S15 and Preparation of Binder Solution S15

A polymer S15 (polyurethane) was synthesized in the same manner as in Synthesis Example S1, and a polymer binder solution S15 consisting of the polymer S15 was obtained except that in Synthesis Example S1, a compound from which each constitutional component was derived was used so that the polymer S15 had the composition (the kind and the content of the constitutional component) shown in Table 1.

### Synthesis Example S16: Synthesis of Polymer S16 and Preparation of Binder Dispersion Liquid S16

A polymer S16 was synthesized in the same manner as in Synthesis Example S7 to obtain a dispersion liquid S16 of a particulate binder (concentration: 10% by mass, particle diameter: 120 nm) consisting of the polymer S16, except that in Synthesis Example S7, a compound from which each constitutional component is derived was used so that the polymers S16 had the composition (the kind and the content of the constitutional component) shown in Table 1.

Each of the synthesized polymers S1 to S3, S5, S6, and S8 to S15 is shown below. It is noted that since the polymer S4 is the same as the polymer S3 except for the content of the constitutional component, the chemical formula thereof is omitted. The number at the lower right of each constitutional component indicates the content (% by mole).

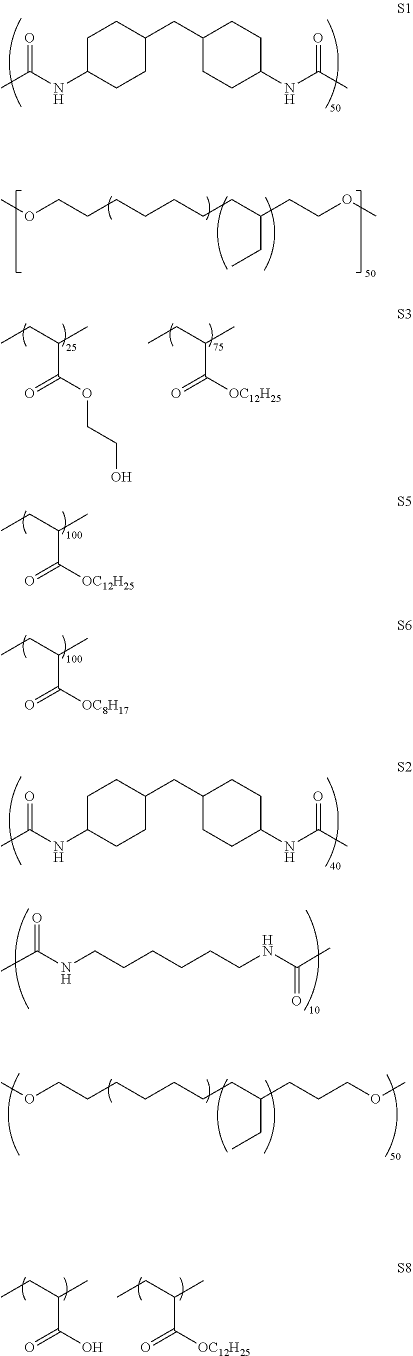

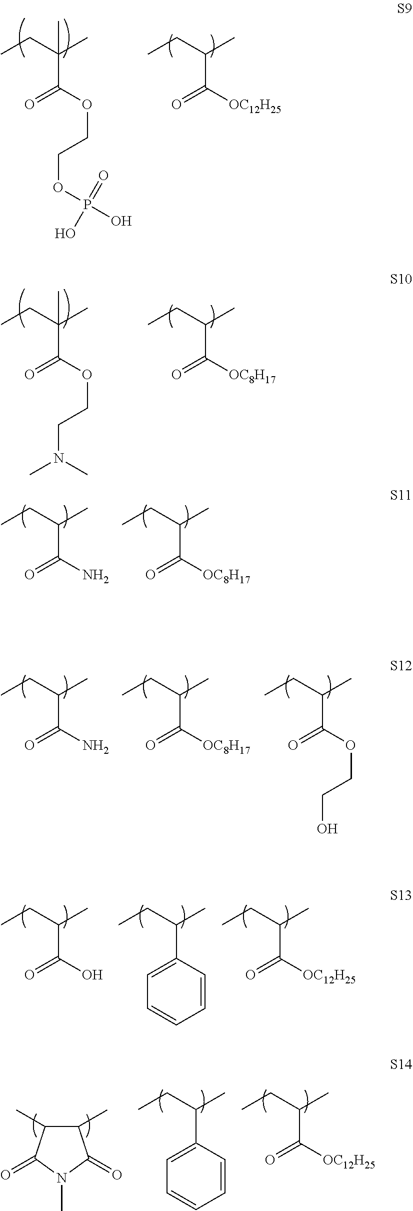

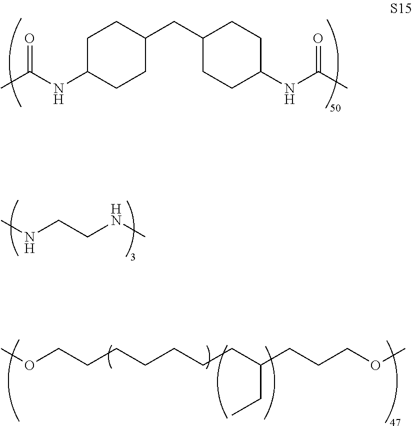

Table 1 shows the composition of each polymer (binder) synthesized, the presence or absence of the functional group, the mass average molecular weight measured according to the above-described method, and the form of the binder (dissolved or insoluble) in the composition, which will described later. It is noted that the unit of the content of each constitutional component is omitted in Table 1, where the unit thereof is “% by mole”. The form of the binder was determined by measuring the solubility in the dispersion medium (butyl butyrate) that was used in each composition, according to the above-described method.

In addition, regarding each of the prepared polymer binders, the adsorption rate A_{SE}with respect to the inorganic solid electrolyte (SE) (LPS having an average particle diameter of 2.5 μm which had been synthesized in Synthesis Example A) which had been used in the preparation of the positive electrode composition described later, and the adsorption rate A_{AC} (%) with respect to the active material (AC) (NMC111) were measured according to the method described above. In addition, the difference in adsorption rate (in terms of the absolute value of the difference between A_{AC} and A_{SE}) was calculated. On the other hand, regarding each of the prepared polymer binders S1 to S4, the adsorption rate A_{SE} with respect to the inorganic solid electrolyte (SE) (LPS having an average particle diameter of 2.5 μm which had been synthesized in Synthesis Example A) which had been used in the preparation of the negative electrode composition described later, and the adsorption rate A_{AC} with respect to the active material (AC) (LTO) were measured according to the method described above. In addition, the difference in adsorption rate (in terms of the absolute value of the difference between A_{AC} and A_{SE}) was calculated. The obtained results are shown in Table 1. It is noted that regarding the polymer binders S1 to S4, “the adsorption rate A_{AC} with respect to the positive electrode active material” and “the adsorption rate A_{AC} with respect to the negative electrode active material” are described together in the column of “A_{AC}” in Table 1 by using “/”, and “the difference between the adsorption rate A_{AC} with respect to the positive electrode active material and the adsorption rate A_{SE} with respect to the inorganic solid electrolyte” and “the difference between the adsorption rate A_{AC} with respect to the negative electrode active material and the adsorption rate A_{SE} with respect to the inorganic solid electrolyte” are described together in the column of “Difference” by using “/”. It is noted that as a result of measuring the adsorption rate A_{SE} and the adsorption rate A_{AC} by using the active material (AC) extracted from the active material of the positive electrode sheet or the negative electrode sheet, which was obtained in <Production of positive electrode sheet for all-solid state secondary battery> described later, the inorganic solid electrolyte (SE), the polymer binder A, and the polymer binder B, as well as the dispersion medium (D) used in the preparation of the positive electrode composition or the negative electrode composition, the same values were obtained.

TABLE 1

| | | | | | | | | | | | Mass | |
|---|---|---|---|---|---|---|---|---|---|---|---|---|
| | Con- | | Con- | | Con- | | | | | | average | |
| | stitutional | | stitutional | | stitutional | | Adsorption rate | | | Functional | molecular | |
| No | component 1 | Content | component 2 | Content | component 3 | Content | A_{AC} | A_{SE} | Difference | group | weight | Form |
| S1 | H12MDI | 50 | GI-3000 | 50 | — | — | 48/44 | 30 | 18/14 | Urethane bond | 48,000 | Dissolved |
| S2 | H12MDI | 40 | HMDI | 10 | GI-3000 | 50 | 27/25 | 18 | 9/7 | Urethane bond | 51,000 | Dissolved |
| S3 | HEA | 25 | LA | 75 | — | — | 28/26 | 46 | 18/20 | Hydroxy group | 52,000 | Dissolved |
| S4 | HEA | 15 | LA | 85 | — | — | 16/15 | 25 | 9/10 | Hydroxy group | 46,000 | Dissolved |
| S5 | LA | 100 | — | — | — | — | 0 | 0 | 0 | Absent | 50,000 | Dissolved |
| S6 | OA | 100 | — | — | — | — | 0 | 0 | 0 | Absent | 38,000 | Dissolved |
| S7 | EA | 90 | AA | 9 | AB-6 | 1 | 50 | 12 | 38 | Carboxy group | 102,000 | Insoluble |
| S8 | AA | 10 | LA | 90 | — | — | 10 | 30 | 20 | Carboxy group | 61,000 | Dissolved |
| S9 | Phosmer M | 3 | LA | 97 | — | — | 8 | 26 | 18 | Phosphate group | 72,000 | Dissolved |
| S10 | DMAEM | 15 | OA | 85 | — | — | 5 | 35 | 30 | Amino bond | 55,000 | Dissolved |
| S11 | Acrylamide | 5 | OA | 95 | — | — | 7 | 21 | 14 | Amide bond | 47,000 | Dissolved |
| S12 | Acrylamide | 5 | OA | 90 | HEA | 5 | 15 | 31 | 16 | Amide bond, | 58,000 | Dissolved |
| | | | | | | | | | | hydroxy group | | |
| S13 | AA | 10 | St | 30 | LA | 60 | 5 | 30 | 25 | Carboxy group, | 56,000 | Dissolved |
| | | | | | | | | | | aryl group | | |
| S14 | NM1 | 3 | St | 50 | LA | 47 | 3 | 22 | 19 | Heterocyclic | 37,000 | Dissolved |
| | | | | | | | | | | group, aryl | | |
| | | | | | | | | | | group | | |
| S15 | H12MDI | 50 | EDA | 3 | GI-3000 | 47 | 50 | 38 | 12 | Urethane group, | 62,000 | Dissolved |
| | | | | | | | | | | urea bond | | |
| S16 | EA | 25 | HEA | 70 | AB-6 | 5 | 22 | 40 | 18 | Hydroxy group | 123,000 | Insoluble |

<Abbreviations in table>
In the table, “—” in the column of the constitutional component indicates that the constitutional component does not have a corresponding constitutional component.
H12MDI: Dicyclohexylmethane 4,4′-diisocyanate (manufactured by Tokyo Chemical Industry Co., Ltd.)
HMDI: Hexamethylene diisocyanate (manufactured by Tokyo Chemical Industry Co., Ltd.)
GI-3000: NISSO-PB GI-3000 (trade name, both-terminal hydroxyl group-hydrogenated polybutadiene, number average molecular weight: 3,100, manufactured by NIPPON SODA Co., Ltd.)
HEA: 2-Hydroxyethyl acrylate (manufactured by FUJIFILM Wako Pure Chemical Corporation)
LA: Dodecyl acrylate (manufactured by Tokyo Chemical Industry Co., Ltd.
OA: Octyl acrylate (manufactured by Tokyo Chemical Industry Co., Ltd.)
EA: Ethyl acrylate (manufactured by Fujifilm Wako Pure Chemical Corporation)
AA: Acrylic acid (manufactured by Fujifilm Wako Pure Chemical Corporation)
AB-6: Polybutyl acrylate in which the terminal functional group is a methacryloyl group (number average molecular weight: 6,000, manufactured by TOAGOSEI Co., Ltd.)
Phosmer M: A methacrylic acid ester having a phosphate group (product name, manufactured by Unichemical Co., Ltd.)
DMAEM: N,N-dimethylaminoethyl (manufactured by FUJIFILM Wako Pure Chemical Corporation)
NMI: N-methylmaleimide (manufactured by FUJIFILM Wako Pure Chemical Corporation)
EDA: Ethylenediamine (manufactured by FUJIFILM Wako Pure Chemical Corporation)
St: Styrene (manufactured by FUJIFILM Wako Pure Chemical Corporation)

For constitutional components having no particular description, compounds manufactured by FUJIFILM Wako Pure Chemical Corporation were used.

### 2. Synthesis of Sulfide-Based Inorganic Solid Electrolyte [Synthesis Example A]

A sulfide-based inorganic solid electrolyte was synthesized with reference to a non-patent document of T. Ohtomo, A. Hayashi, M. Tatsumisago, Y Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC, purity: >99.98%) (2.42 g) and diphosphorus pentasulfide (P₂S₅, manufactured by Sigma-Aldrich Co., LLC, purity: >99%) (3.90 g) each were weighed, put into an agate mortar, and mixed using an agate pestle for five minutes. The mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above lithium sulfide and the diphosphorus pentasulfide was put thereinto, and the container was sealed in an argon atmosphere. The container was set in a planetary ball mill P-7 (product name, manufactured by FRITSCH), mechanical milling (micronization) was carried out at a temperature of 25° C. and a rotation speed of 510 rpm for 20 hours, thereby obtaining 6.20 g of a yellow powder of a sulfide-based inorganic solid electrolyte (Li/P/S glass, hereinafter, may be denoted as LPS). The particle diameter (the volume average particle diameter) of the LPS was 8 μm.

Wet-type dispersion was carried out using the obtained LPS under the following conditions to adjust the particle diameter of the LPS.

That is, 160 zirconia beads having a diameter of 5 mm were put into a 45 mL zirconia container (manufactured by Fritsch Japan Co., Ltd.), and 4.0 g of the synthesized LPS and 6.0 g of diisobutyl ketone as an organic solvent were added thereto. Then the container was set in a planetary ball mill P-7, and wet-type dispersion was carried out at 250 rpm for 30 minutes to obtain an LPS having a particle diameter (volume average particle diameter) of 2.5 μm.

### Example 1

### Preparation of Positive Electrode Composition (Slurry)S-1

70 parts by mass of NMC111 (lithium nickel manganese cobalt oxide, particle diameter: m, manufactured by Sigma-Aldrich Co., LLC) as the positive electrode active material (AC), 27 parts by mass of the LPS (particle diameter: 2.5 μm) obtained in the above-described Synthesis Example A as the inorganic solid electrolyte (SE), 2.3 parts by mass of acetylene black (particle diameter: 0.1 μm, manufactured by Denka Company Limited) as the conductive auxiliary agent (CA), 0.7 parts by mass of the polymer binder solution S1 as the polymer binder A (in terms of solid contents), 0.27 parts by mass of the polymer binder solution S3 as the polymer binder B (in terms of solid contents), and the dispersion medium (D) were mixed according to the following steps 1, 2, and 3 to prepare a positive electrode composition (concentration of solid contents: 65% by mass) S-1.

### (Step 1: Preparation Step for Active Material Composition)

20 g of zirconia beads having a diameter of 3 mm was added to a 45 mL container made of zirconia (manufactured by FRITSCH), and further, 70 parts by mass of the positive electrode active material, 0.7 parts by mass of the binder solution S1 (in terms of solid contents), and butyl butyrate as the dispersion medium were added thereto to adjust the concentration of solid contents to 70% by mass. Thereafter, the container was set in a planetary ball mill P-7 (trade name, manufactured by Fritsch Japan Co., Ltd.), and stirring was carried out for 30 minutes hours at a temperature of 25° C. and a rotation speed of 100 rpm to obtain an active material composition S1-1 having a concentration of solid contents of 70% by mass.

### (Step 2: Preparation Step for Solid Electrolyte Composition—

20 g of zirconia beads having a diameter of 3 mm was added to a 45 mL container made of zirconia (manufactured by FRITSCH), and further, 27 parts by mass of the inorganic solid electrolyte, 0.27 parts by mass of the binder solution S3 (in terms of solid contents), and butyl butyrate as the dispersion medium were added thereto to adjust the concentration of solid contents to 60% by mass. Thereafter, this container was set in a planetary ball mill P-7, and stirring was carried out at a temperature of 25° C. and a rotation speed of 100 rpm for 30 minutes to obtain a solid electrolyte composition S1-2 having a solid content concentration of 60% by mass.

### (Step 3: Preparation Step for Electrode Composition)

20 g of zirconia beads having a diameter of 3 mm was added to a 45 mL container made of zirconia (manufactured by FRITSCH). Further, the entire amount of the active material composition S1-1 obtained in the step 1, the entire amount of the solid electrolyte composition S1-2 obtained in the step 2, and 2.3 parts by mass of acetylene black, as well as a dispersion medium required to adjust the solid content concentration of the positive electrode composition to be obtained to 65% by mass, were added thereto. Thereafter, the container was set in a planetary ball mill P-7, and stirring was carried out at a temperature of 25° C. and a rotation speed of 100 rpm for 30 minutes to obtain a positive electrode composition S-1 (concentration of solid contents: 65% by mass).

### <Preparation of Positive Electrode Compositions (Slurries) S-2 to S-24>

Each of positive electrode compositions (slurries) S-2 to S-24 was prepared in the same manner as in the preparation of the positive electrode composition (slurry) S-1, except that in the preparation of the positive electrode composition (slurry) S-1, the kind or content of the polymer binder A and the kind or content of the polymer binder B, as well as the content of the conductive auxiliary agent, were changed as shown in Table 2-1.

### <Preparation of Negative Electrode Compositions (Slurries) T-1 to T-4>

Each of negative electrode compositions (slurries) T-1 to T-4 was prepared in the same manner as in the preparation of the positive electrode composition (slurry) S-1, except that in the preparation of the positive electrode composition (slurry) S-1, the kind or content of the polymer binder A and the kind or content of the polymer binder B, as well as the kind and content of each of the active material and the conductive auxiliary agent, were changed as shown in Table 2-2.

Table 2-1 and Table 2-2 (collectively referred to as Table 2), that is, Table 2 shows the difference (in terms of absolute value) between the polymer binder A and the polymer binder B, which is determined regarding each of the adsorption rate A_{AC} and the adsorption rate A_{SE}.

None of the polymer binders S5 to S7 and S16 correspond to the polymer binders A and B which are defined in the present invention; however, for convenience, the polymer binder used in the step 1 is described in the column of “Binder A”, and the polymer binder used in the step 2 is described in the column of “Binder B” in the positive electrode compositions S-3 to S-10 and S-24 shown in Table 2.

It is noted that in Table 2, the content of each component indicates the mixing amount (in terms of parts by mass) used in the preparation of each composition, where the unit is omitted in the table.

TABLE 2

| | Positive | | | | | | | | | | | | |
|---|---|---|---|---|---|---|---|---|---|---|---|---|---|
| | electrode | | Solid | | | | | | Conductive | | Difference in | | |
| | active material | | electrolyte | | Binder | | Binder | | auxiliary | | adsorption rate (%) | | |
| No. | (AC) | Content | (SE) | Content | A | Content | B | Content | agent | Content | A_{AC} | A_{SE} | Note |
| S-1 | NMC111 | 70 | LPS | 27 | S1 | 0.7 | S3 | 0.27 | AB | 2j | 20 | 16 | Present |
| | | | | | | | | | | | | | invention |
| S-2 | NMC111 | 70 | LPS | 27 | S2 | 0.7 | S4 | 0.27 | AB | 2.3 | 11 | 7 | Present |
| | | | | | | | | | | | | | invention |
| S-3 | NMC111 | 70 | LPS | 27 | S1 | 0.97 | — | — | AB | 2.3 | — | — | Comparative |
| | | | | | | | | | | | | | Example |
| S-4 | NMC111 | 70 | LPS | 27 | — | — | S3 | 0.97 | AB | 2.3 | — | — | Comparative |
| | | | | | | | | | | | | | Example |
| S-5 | NMC111 | 70 | LPS | 27 | S5 | 0.7 | S3 | 0.27 | AB | 2.3 | 28 | 46 | Comparative |
| | | | | | | | | | | | | | Example |
| S-6 | NMC111 | 70 | LPS | 27 | S1 | 0.7 | S5 | 0.27 | AB | 2.3 | 48 | 30 | Comparative |
| | | | | | | | | | | | | | Example |
| S-7 | NMC111 | 70 | LPS | 27 | S5 | 0.7 | S6 | 0.27 | AB | 2.3 | 0 | 0 | Comparative |
| | | | | | | | | | | | | | Example |
| S-8 | NMC111 | 70 | LPS | 25 | S5 | 2.0 | S6 | 1.0 | AB | 2.0 | 0 | 0 | Comparative |
| | | | | | | | | | | | | | Example |
| S-9 | NMC111 | 70 | LPS | 27 | S6 | 0.7 | S3 | 0.27 | AB | 2.3 | 28 | 46 | Comparative |
| | | | | | | | | | | | | | Example |
| S-10 | NMC111 | 70 | LPS | 27 | S7 | 0.7 | S3 | 0.27 | AB | 2.3 | 22 | 34 | Comparative |
| | | | | | | | | | | | | | Example |
| S-11 | NMC111 | 70 | LPS | 27 | S1 | 0.7 | S8 | 0.27 | AB | 2.3 | 38 | 0 | Present |
| | | | | | | | | | | | | | invention |
| S-12 | NMC111 | 70 | LPS | 27 | S1 | 0.7 | S9 | 0.27 | AB | 2.3 | 40 | 4 | Present |
| | | | | | | | | | | | | | invention |
| S-13 | NMC111 | 70 | LPS | 27 | S1 | 0.7 | S10 | 0.27 | AB | 2.3 | 43 | 5 | Present |
| | | | | | | | | | | | | | invention |
| S-14 | NMC111 | 70 | LPS | 27 | S1 | 0.7 | S11 | 0.27 | AB | 2.3 | 41 | 9 | Present |
| | | | | | | | | | | | | | invention |
| S-15 | NMC111 | 70 | LPS | 27 | S1 | 0.7 | S12 | 0.27 | AB | 2.3 | 33 | 1 | Present |
| | | | | | | | | | | | | | invention |
| S-16 | NMC111 | 70 | LPS | 27 | S1 | 0.7 | S13 | 0.27 | AB | 2.3 | 43 | 0 | Present |
| | | | | | | | | | | | | | invention |
| S-17 | NMC111 | 70 | LPS | 27 | S1 | 0.7 | S14 | 0.27 | AB | 2.3 | 45 | 8 | Present |
| | | | | | | | | | | | | | invention |
| S-18 | NMC111 | 70 | LPS | 27 | S15 | 0.7 | S3 | 0.27 | AB | 2.3 | 22 | 8 | Present |
| | | | | | | | | | | | | | invention |
| S-19 | NMC111 | 70 | LPS | 27 | S15 | 0.7 | S12 | 0.27 | AB | 2.3 | 35 | 7 | Present |
| | | | | | | | | | | | | | invention |
| S-20 | NMC111 | 70 | LPS | 27 | S15 | 0.7 | S13 | 0.27 | AB | 2.3 | 45 | 8 | Present |
| | | | | | | | | | | | | | invention |
| S-21 | NMC111 | 70 | LPS | 27 | S2 | 0.7 | S3 | 0.27 | AB | 2.3 | 1 | 28 | Present |
| | | | | | | | | | | | | | invention |
| S-22 | NMC111 | 70 | LPS | 27 | S1 | 0.7 | S4 | 0.27 | AB | 2.3 | 32 | 5 | Present |
| | | | | | | | | | | | | | invention |
| S-23 | NMC111 | 70 | LPS | 27 | S15 | 0.25 | S12 | 0.75 | AB | 2.3 | 35 | 7 | Present |
| | | | | | | | | | | | | | invention |
| S-24 | NMC111 | 70 | LPS | 27 | S1 | 0.25 | S16 | 0.75 | AB | 2.3 | 26 | 10 | Comparative |
| | | | | | | | | | | | | | Example |
| T-1 | LTO | 60 | LPS | 35 | S1 | 0.7 | S3 | 0.27 | AB | 4.3 | 18 | 16 | Present |
| | | | | | | | | | | | | | invention |
| T-2 | LTO | 60 | LPS | 35 | S2 | 0.7 | S4 | 0.27 | AB | 4.3 | 10 | 7 | Present |
| | | | | | | | | | | | | | invention |
| T-3 | LTO | 60 | LPS | 35 | S1 | 0.97 | — | — | AB | 4.3 | — | — | Comparative |
| | | | | | | | | | | | | | Example |
| T-4 | LTO | 60 | LPS | 35 | — | — | S3 | 0.97 | AB | 4.3 | — | — | Comparative |
| | | | | | | | | | | | | | Example |

<Abbreviations in table>
NMC111: LiNi_{1/3}Co_{1/3}Mn_{1/3}O₂ (manufactured by Sigma-Aldrich Co., LLC)
LPS: LPS having a particle diameter of 2.5 μm, which is synthesized in Synthesis Example A
AB: Acetylene black (manufactured by Denka Company Limited)
LTO: Lithium titanate (manufactured by Sigma-Aldrich Co., LLC)

<Production of Positive Electrode Sheet for all-Solid State Secondary Battery>

Each of the positive electrode compositions S-1 to S-24 obtained as above was applied onto an aluminum foil having a thickness of 20 μm by using a baker type applicator (product name: SA-201, manufactured by Tester Sangyo Co., Ltd.), followed by heating at 100° C. for 1 hour to dry (to remove the dispersion medium) the positive electrode composition. In this way, a positive electrode active material layer was formed on the aluminum foil to produce each of positive electrode sheets P-1 to P-24 for an all-solid state secondary battery. The thickness of the positive electrode active material layer was 110 m.

<Production of Negative Electrode Sheet for all-Solid State Secondary Battery>

Each of the negative electrode compositions T-1 to T-4 obtained as above was applied onto a stainless steel (SUS) foil having a thickness of 20 μm by using a baker type applicator (product name: SA-201, manufactured by Tester Sangyo Co., Ltd.), followed by heating at 100° C. for 1 hour to dry (to remove the dispersion medium) the negative electrode composition. In this way, a negative electrode active material layer was formed on the SUS foil to produce each of negative electrode sheets N-1 to N-4 for an all-solid state secondary battery. The thickness of the negative electrode active material layer was 100 μm.

<Manufacturing of all-Solid State Secondary Battery>

Each of the produced positive electrode sheets P-1 to P-24 for an all-solid state secondary battery or the produced negative electrode sheets N-1 to N-4 for an all-solid state secondary battery was punched into a disk shape having a diameter of 10 mm and was placed in a cylinder made of polyethylene terephthalate (PET) having an inner diameter of 10 mm. 30 mg of the LPS having a particle diameter of 2.5 μm, which had been obtained in Synthesis Example A, was placed on the positive electrode active material layer side in each cylinder, and a rod made of stainless steel (an SUS rod) having a diameter of 10 mm was inserted from the openings at both ends of the cylinder. The collector side of each positive electrode sheet for an all-solid state secondary battery and the LPS were pressurized by applying a pressure of 350 MPa with a SUS rod. The SUS rod on the LPS side was once removed, and a disk-shaped In sheet having a diameter of 9 mm (thickness: 20 μm) and a disk-shaped Li sheet having a diameter of 9 mm (thickness: 20 μm) were inserted in this order onto the LPS in the cylinder. The removed SUS rod was inserted again into the cylinder and the sheets were fixed while applying a pressure of 50 MPa.

In this manner, each of all-solid state secondary batteries (positive electrode half cells) Nos. C-1 to C-24, which had a configuration of aluminum foil (thickness: 20 μm)—positive electrode active material layer (thickness: 70 μm)—solid electrolyte layer (thickness: 200 μm)—negative electrode active material layer (In/Li sheet, thickness: 30 μm) and all-solid state secondary batteries (negative electrode half cells) Nos. C-25 to C-28, which had a configuration of SUS foil (thickness: 20 μm)—negative electrode active material layer (thickness: 70 μm)—solid electrolyte layer (thickness: 200 μm)—positive electrode active material layer (In/Li sheet, thickness: 30 μm) was manufactured.

The following evaluations were carried out for each of the manufactured compositions, each of the manufactured sheets, and each of the manufactured all-solid state secondary batteries, and the results thereof are shown in Table 3-1 and Table 3-2 (collectively referred to as Table 3).

### <Evaluation 1: Dispersion Stability Test>

Each of the prepared compositions (slurries) S-1 to S-24 and T-1 to T-4 was put into a glass test tube having a diameter of 10 mm and a height of 4 cm up to a height of 4 cm and allowed to stand at 25° C. for 3 hours. The solid content ratio between the solid contents before and after allowing the standing was calculated regarding the slurry within 1 cm from the slurry liquid surface. Specifically, immediately after allowing the standing, the liquid down to 1 cm below the slurry liquid surface was taken out and dried by heating in an aluminum cup at 120° C. for 3 hours. Then, the mass of the solid content in the cup was measured to determine the solid content before and after allowing the standing. The solid content obtained in this manner was used to determine the solid content ratio [W2/W1] of the solid content W2 after allowing the standing to the solid content W1 before allowing the standing.

The ease of sedimentation (sedimentary property) of each of the active material (AC) and the inorganic solid electrolyte (SE) was evaluated as the dispersion stability of the solid electrolyte composition by determining where this solid content ratio [W2/W1] is included in any of the following evaluation standards. In this test, it is indicated that the closer the solid content ratio [W2/W1] is to 1, the better the dispersion stability is, and the evaluation standard “B” or higher is the pass level.

It is noted that the electrode compositions S-1, S-2, S-11 to 5-23, T-1, and T-2 were also excellent in the dispersibility immediately after preparation. On the other hand, the solid content ratios [W2/W1] of the electrode compositions S-3 and S-4 were 0.58 and 0.61, respectively.

### —Evaluation Standards—

S: 0.95≤[W2/W1]≤1.0
A: 0.90≤[W2/W1]<0.95
B: 0.8≤[W2/W1]<0.90
C: [W2/W1]<0.8

### <Evaluation 2: Bonding Property Test (Vibration Test)>

A disk-shaped test piece, which had been obtained by punching each of the produced positive electrode sheets P-1 to P-24 for an all-solid state secondary battery and each of the produced negative electrode sheets N-1 to N-4 for an all-solid state secondary battery into a disk shape having a diameter of 10 mm, was disposed and sealed on the bottom surface of a screw tube (manufactured by Maruemu Corporation, No. 6, capacity: 30 mL, body diameter: 30 mm x total length: 65 mm), without fixing the disk-shaped test piece, so that the active material layer was on the upper side. This screw tube was fixed to a test tube mixer (trade name: Delta Mixer Se-40, manufactured by TAITEC CORPORATION), the amplitude was set to 2,800 rpm, and vibration was applied for 30 seconds.

Regarding the disk-shaped test piece taken out from the screw tube after this vibration test, the proportion of the lacking active material layer was determined as a mass ratio [WB2/WB1] of a mass WB2 of the test piece after the vibration to a mass WB1 of the test piece before the vibration.

In this test, it is indicated that the closer the mass ratio [WB2/WB1] is to 1, the more firm the binding force between the solid particles that constitute the active material layer is, where an evaluation standard “B” or higher is the pass level.

### —Evaluation Standards—

A: 0.99≤[WB2/WB1]≤1.0
B: 0.95≤[WB2/WB1]<0.99
C: [WB2/WB1]<0.95

### <Evaluation 3: Resistance Test>

The battery resistance of each of the manufactured all-solid state secondary batteries was evaluated according to the following method.

Specifically, using each of the manufactured all-solid state secondary batteries (half cells) Nos. C-1 to C-28, charging was carried out in an environment of 25° C. under the condition of a charging current value of 0.1 mA until the battery voltage reached 3.6 V. Thereafter, discharging was carried out under the condition of a discharging current value of 0.1 mA until the battery voltage reached 1.9 V to initialize each of the all-solid state secondary batteries.

Thereafter, as a rate test, charging was carried out in an environment of 25° C. under the condition of a charging current value of 0.1 mA until the battery voltage reached 3.6 V, and subsequently, discharging was carried out under the condition of a discharging current value of 0.1 mA until the battery voltage reached 1.9 V (a charging and discharging step (1)). Thereafter, charging was carried out under the condition of a charging current value of 0.1 mA until the battery voltage reached 3.6 V, and subsequently, discharging was carried out under the condition of a discharging current value of 1.5 mA until the battery voltage reached 1.9 V (a charging and discharging step (2)).

After the charging and discharging steps (1) and (2) were completed, the discharge capacity was measured using a charging and discharging evaluation device TOSCAT-3000 (trade name, manufactured by Toyo System Co., Ltd.). Using the measured discharge capacity, the retention rate (%) of the discharge capacity was calculated from the following expression and applied to the following evaluation standards to evaluate the rate characteristics of the all-solid state secondary battery.

In this test, it is indicated that the higher the retention rate (%) is, the lower the battery resistance (the resistance of the positive electrode active material layer) of the all-solid state secondary battery is, and an evaluation standard “B” or higher is the pass level in this test.

Retention rate (%)=[discharge capacity in charging and discharging step (2)/discharge capacity in charging and discharging step (1)]×100

### —Evaluation Standards—

A: 90%≤retention rate
B: 80%≤retention rate <90%
C: retention rate <80%

TABLE 3

| | Electrode composition | Battery | Dispersion | Bonding | Battery | |
|---|---|---|---|---|---|---|
| | No. | No. | stability | property | resistance | Note |
| Positive electrode | | | | | | |
| sheet | | | | | | |
| No. | | | | | | |
| P-1 | S-1 | C-1 | A | A | A | Present |
| | | | | | | invention |
| P-2 | S-2 | C-2 | A | A | A | Present |
| | | | | | | invention |
| P-3 | S-3 | C-3 | C | B | A | Comparative |
| | | | | | | Example |
| P-4 | S-4 | C-4 | C | B | A | Comparative |
| | | | | | | Example |
| P-5 | S-5 | C-5 | C | B | B | Comparative |
| | | | | | | Example |
| P-6 | S-6 | C-6 | C | B | B | Comparative |
| | | | | | | Example |
| P-7 | S-7 | C-7 | C | C | B | Comparative |
| | | | | | | Example |
| P-8 | S-8 | C-8 | A | A | C | Comparative |
| | | | | | | Example |
| P-9 | S-9 | C-9 | C | B | B | Comparative |
| | | | | | | Example |
| P-10 | S-10 | C-10 | C | A | A | Comparative |
| | | | | | | Example |
| p-11 | S-11 | C-11 | A | A | A | Present |
| | | | | | | invention |
| P-12 | S-12 | C-12 | A | A | A | Present |
| | | | | | | invention |
| P-13 | S-13 | C-13 | A | A | A | Present |
| | | | | | | invention |
| P-14 | S-14 | C-14 | B | A | A | Present |
| | | | | | | invention |
| P-15 | S-15 | C-15 | S | A | A | Present |
| | | | | | | invention |
| P-16 | S-16 | C-16 | S | A | A | Present |
| | | | | | | invention |
| P-17 | S-17 | C-17 | B | A | A | Present |
| | | | | | | invention |
| P-18 | S-18 | C-18 | A | A | A | Present |
| | | | | | | invention |
| P-19 | S-19 | C-19 | S | A | A | Present |
| | | | | | | invention |
| P-20 | S-20 | C-20 | S | A | A | Present |
| | | | | | | invention |
| P-21 | S-21 | C-21 | B | A | A | Present |
| | | | | | | invention |
| P-22 | S-22 | C-22 | A | A | A | Present |
| | | | | | | invention |
| P-23 | S-23 | C-23 | S | A | A | Present |
| | | | | | | invention |
| P-24 | S-24 | C-24 | C | B | C | Comparative |
| | | | | | | Example |
| Negative electrode | | | | | | |
| sheet | | | | | | |
| No. | | | | | | |
| N-1 | T-1 | C-25 | A | A | A | Present |
| | | | | | | invention |
| N-2 | T-2 | C-26 | A | A | A | Present |
| | | | | | | invention |
| N-3 | T-3 | C-27 | C | B | A | Comparative |
| | | | | | | Example |
| N-4 | T-4 | C-28 | C | B | A | Comparative |
| | | | | | | Example |

The following facts can be seen from the results of Table 1 to Table 3.

All the electrode compositions S-3 to S-10, S-24, T-3, and T-4 of Comparative Examples, which do not contain the polymer binders A and B that preferentially adsorb to the active material (AC) and the inorganic solid electrolyte (SE), respectively, cannot achieve a balance between the dispersion stability of the electrode composition, the bonding property of the solid particles in the active material layer, and the battery resistance (the resistance of the active material layer). Specifically, the electrode compositions S-3 to S-7, S-9, T-3, and T-4 are inferior in dispersion stability. In addition, although the electrode composition S-8 excessively containing two kinds of polymer binders that do not correspond to the polymer binders A and B has excellent dispersion stability, the battery resistance (the resistance of the positive electrode active material layer) is large. The positive electrode composition S-10 containing a particulate polymer binder is inferior in dispersion stability, and the positive electrode composition S-24 is inferior in dispersion stability and battery resistance.

On the other hand, all the electrode compositions S-1, S-2, S-11 to S-23, T-1, and T-2, which contain, in the dispersion medium (D), the polymer binders A and B that preferentially adsorb to the active material (AC) and the inorganic solid electrolyte (SE), respectively, are excellent in the dispersion stability, the bonding property of solid particles, and the battery resistance, and they can achieve a balance between them at a high level.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery

What is claimed is:

1. An electrode composition comprising:
an inorganic solid electrolyte having an ion conductivity of a metal belonging to Group 1 or Group 2 in the periodic table;
an active material;
a polymer binder; and
a dispersion medium,
wherein the polymer binder includes;
a polymer binder A that is a polymer binder which is dissolved in the dispersion medium, where an adsorption rate with respect to the active material in the dispersion medium is 20% or more and is higher than an adsorption rate with respect to the inorganic solid electrolyte, and
a polymer binder B that is a polymer binder which is dissolved in the dispersion medium, where an adsorption rate with respect to the inorganic solid electrolyte in the dispersion medium is 20% or more and is higher than an adsorption rate with respect to the active material.

2. The electrode composition according to claim 1, further comprising:
a conductive auxiliary agent.

3. The electrode composition according to claim 1,
wherein a polymer that forms at least one of the polymer binder A or the polymer binder B contains a constitutional component having a functional group selected from the following group (a) of functional groups,
<Group (a) of functional groups>
a hydroxy group, an amino group, a carboxy group, a sulfo group, a phosphate group, a phosphonate group, a sulfanyl group, an ether bond, an imino group, an amide bond, an imide bond, a urethane bond, a urea bond, a heterocyclic group, an aryl group, and a carboxylic acid anhydride group.

4. The electrode composition according to claim 1,
wherein a polymer that forms the polymer binder A has, in a main chain, at least one bond of a urethane bond, a urea bond, an amide bond, an imide bond, or an ester bond.

5. The electrode composition according to claim 1,
wherein a polymer that forms the polymer binder B is obtained by polymerizing a monomer having a carbon-carbon unsaturated bond.

6. The electrode composition according to claim 1,
wherein a content of the polymer binder A is 1.5% by mass or less in 100% by mass of a solid content of the electrode composition, and
a content of the polymer binder B is 1.5% by mass or less in 100% by mass of the solid content of the electrode composition.

7. An electrode sheet for an all-solid state secondary battery, comprising:
an active material layer formed of the electrode composition according to claim 1.

8. An all-solid state secondary battery comprising, in the following order:
a positive electrode active material layer;
a solid electrolyte layer; and
a negative electrode active material layer,
wherein at least one of the positive electrode active material layer or the negative electrode active material layer is an active material layer formed of the electrode composition according to claim 1.

9. A production method for an electrode composition, which is a production method for the electrode composition according to claim 1, the production method comprising:
a step of preparing an active material composition containing the active material, the polymer binder A, and the dispersion medium;
a step of preparing a solid electrolyte composition containing the inorganic solid electrolyte, the polymer binder B, and the dispersion medium; and
a step of mixing the active material composition with the solid electrolyte composition.

10. A manufacturing method for an electrode sheet for an all-solid state secondary battery, the manufacturing method comprising:
forming a film of the electrode composition according to claim 1.

11. A manufacturing method for an all-solid state secondary battery, the manufacturing method comprising:
manufacturing an all-solid state secondary battery through the manufacturing method according to claim 10.
